(19) United States
(12) Patent Application Publication
(10) Pub. No.: US 2022/0083208 A1
(43) Pub. Date: Mar. 17, 2022

(54) NON-PROPORTIONALLY TRANSFORMING AND INTERACTING WITH OBJECTS IN A ZOOMABLE USER INTERFACE

(71) Applicant: Linecept, Inc., Dana Point, CA (US)

(72) Inventor: David Tamas Kutas, Dana Point, CA (US)

(21) Appl. No.: 17/363,342

(22) Filed: Jun. 30, 2021

Related U.S. Application Data
(60) Provisional application No. 63/077,788, filed on Sep. 14, 2020.

(51) Int. Cl. G06F 3/0484; G06F 3/0485; G06F 3/0481

(52) U.S. Cl. CPC G06F 3/04845; G06F 2203/04806; G06F 3/0481; G06F 3/0485

(57) ABSTRACT

A method for performing a magnification operation on a graphical user interface includes receiving a user selection of an object displayed on a graphical user interface, determining initial spatial dimensions of the selected object, determining initial spatial dimensions of one or more non-selected objects displayed on the graphical user interface, determining spatial dimensions of a viewing window of the graphical user interface, and, in response to the user selection, positioning the selected object in a center of the viewing window, calculating final spatial dimensions of the selected object based on the spatial dimensions of the viewing window, and calculating final spatial dimensions of the non-selected object(s) based on the initial spatial dimensions of the selected object, the final spatial dimensions of the selected object, and the initial spatial dimensions of the non-selected object(s). The selected object and non-selected object(s) may be transformed according to their respective calculated final spatial dimensions.

### CROSS-REFERENCE TO RELATED APPLICATIONS

This application relates to and claims the benefit of U.S. Provisional Application No. 63/077,788, filed Sep. 14, 2020 and entitled “Enhanced Method and System for Non-Proportionally Transforming and Interacting with Objects in a Zoomable User Interface,” the entire contents of which is expressly incorporated herein by reference.

### STATEMENT RE: FEDERALLY SPONSORED RESEARCH/DEVELOPMENT

Not Applicable

### BACKGROUND

### 1. Technical Field

The present disclosure relates generally to a graphical user interface (GUI) and, more specifically, to a zoomable user interface (ZUI) that can be interacted with through a magnification metaphor to display information in multiple (e.g. two) levels of magnification to users of computer systems.

### 2. Related Art

A graphical user interface (GUI) is a human-computer interface that gained popularity in the early 1980s and provides a visual way for people to interact with computers through two-dimensional metaphors such as icons, buttons, and windows. GUIs are present in nearly all modern operating systems. With the emergence of the multi-device and multi-screen world starting in the 2000s and its ubiquity in the second half of the 2000s and 2010s, a contemporary user interface design emerged, called responsive user interface design. With responsive user interface design, all of the real estate on a viewing window can be dynamically, efficiently utilized, as the presentable content responds to the potentially mutable constraints given by the viewing window.

In 2003, a more advanced human-computer interaction started to gain widespread commercial success: the zoomable user interface (ZUI), as exemplified by the Mission Control feature of Apple's OSX 10.3 Panther operating system. A ZUI is a type of GUI that adds a third dimension (Z-axis or depth) to the metaphors used in GUIs. In a ZUI, users are able to interact with objects and data through magnification in three-dimensional space without changing the view angle of the objects. Essentially, this allows the presentable information to exist in a multi-scale environment. Navigation in a ZUI is two-fold: depth navigation to access different data layers (Z axis) and surface navigation (X and Y plane) to navigate on a particular data layer.

In a traditional GUI, information on a webpage or display is represented in two dimensions and the user needs to scroll up and down to reveal information that may reside outside of view. However, in a ZUI, in addition to the previous orientation and navigation methods, users can zoom in or out of a particular information object represented on a screen to reveal additional information (in other words, add or remove a data layer through navigation along the Z axis). ZUI capitalizes on magnification-based metaphors to reveal more information about a particular object. Coupling the magnification with smooth (more than 30 frames per second and ideally at least 60 frames per second) animation while transforming objects makes the human-computer interaction feel more natural to humans, as it is human nature to learn more about a physical object by getting closer to it.

ZUIs, as the main interface category, can be broken down into two main subcategories: geometric and semantic. They differ on the following dimensions:
Information Retrieval: whether new data is added to the system or not during zooming in or out, respectively;
Object Representation: how objects change visually when the user interacts with the given ZUI;
Depth Navigation: how the user navigates between different ZUI depth layers; and
Surface Navigation: how the user navigates on a ZUI surface layer.

In the geometric ZUI subcategory, new details of an object or display are not brought in (i.e., the presented information does not change at different levels of zoom) and the physical rules of magnification are obeyed when the interaction is happening on the interface (i.e., the aspect ratios of the object or display remain the same at different levels of magnification). An example of a geometric ZUI is simple magnification, i.e. when a user zooms into an image. In this case, no new data is bound to the interface. The artifact scale merely changes proportionally.

On the other hand, in the semantic subcategory, new details of an object or display can be added or removed. That is, the type and amount of information at different levels of zoom can change. Further, physical rules of magnification can be contravened (i.e., objects can freely change shape, appear, or disappear). More specifically, a semantic ZUI can mimic and change some characteristics of the visual representation of objects while the zooming is happening. An example of a semantic ZUI is online maps (e.g., Google Maps). When a user zooms into a segment of the map, new artifacts appear (e.g., smaller streets and street names are revealed). When a user zooms out, different data is represented (e.g., smaller streets disappear while highways and their respective names appear).

Within semantic ZUIs, there are four further subcategories: generic, special geometric projections, fisheye, and flip zoom. Generic zoomable user interfaces are like the geometric ZUI, so that magnification is based on a one-point perspective scale, but when the magnification is happening new data is brought to the interface. An example of this type of ZUI is ChronoZoom. Special geometric projection zoomable interfaces are interfaces where the magnification rules are tied to certain geometric projections such as Mercator-projection. An example type of software product is Google Maps. In fisheye ZUIs, arbitrary center(s) of the viewed objects can be assigned, and magnification of the center occurs simultaneously with the continuous fall-off in magnification of the peripheries of the objects. Some examples of this type of interface are the Dock of the desktop operating system by Apple, Inc. or the app launcher screen on the Apple Watch. On the app launcher screen on the Apple Watch, the application icon in the center of the screen is always magnified, whereas the other icons on the periphery are visibly smaller (i.e., only magnified slightly or not at all). This creates a focus on the object of interest while still providing context regarding the object's surroundings.

In flip zoom ZUIs, information is visualized through a number of distinct objects with an arbitrary order. As a zoom metaphor, flip zooming uses a simple perspective scale that only affects the object in the focus, while non-focused objects remain unaffected.

Each of these interaction methods has its drawbacks. Importantly, the use of multiple devices (e.g., laptops, tablets, smartphones, smartwatches), each with differing screen sizes, has become increasingly commonplace and standard. As a result, existing ZUIs are becoming increasingly inadequate in providing users with an interface that works well universally across different screens and sizes. People are frequently transitioning their work from one device to another, requiring a human-computer interface that optimally adapts to the user's needs. Problematically, the geometric and existing semantic ZUI categories were not designed to operate in the multi-device world we now live in (especially generic, fisheye, and flip zoom, whereas special map projection based ZUIs have a very specific field of use). While they do provide good human-computer interaction experiences in some cases, geometric and generic semantic ZUIs really only work well when the aspect ratio of the object closely matches the aspect ratio of the screen on which it is displayed. In every other case, when the aspect ratios are not well aligned, the human-computer interaction experience is less desirable for humans (i.e., the magnified object will either be too big, too small, cut off, or otherwise not fitting adequately on the screen). For example, portions of a text or image might be cut off from view or may be too small to read or view. The degree of detrimental impact on the human-computer interaction experience varies widely depending on the difference in aspect ratios between the represented objects and the viewing window. However, with the aspect ratios for television screens being vastly different from those of smartwatches, for example, this issue arises frequently, particularly for geometric ZUIs.

While wasted space and cutting off portions of the object are less common and less problematic in fisheye and flip zoom ZUIs, these interfaces are still limited in some respects. First, interacting with the fisheye ZUI can be cognitively demanding for users. There are many moving parts to the fisheye animation: the selected object increasing in size and magnifying while the non-selected objects fall to the periphery and decrease in size (hence the location of information is dynamic and keeps changing based on the focal point of the magnification), causing continuous context switching for the human brain. Similarly, when a user clicks on an object in a flip zoom ZUI, the selected object magnifies, and at the same time the previously central object shrinks. All of this simultaneous movement can create a sense of “motion sickness” and distract the user from the content within those objects. Further, in both the fisheye and flip zoom ZUIs, the non-selected peripheral objects are always shown. In cases where it is important for the user to focus their attention exclusively on the selected object, the smaller periphery objects can be distracting and detract from the key message. In fisheye and flip zoom ZUIs, there is no option to remove the contextual objects on the peripheries. The user's locus of attention (resistance to distraction) is thus at risk of being diverted by the periphery objects that are always there. While having contextual objects can be beneficial in some instances to help orient the user, forcing them to always be visible also increases the cognitive effort that the user must exert. It takes greater effort to stay focused on the primary, selected object and to keep track of the multiple animations that are happening on the screen at the same time.

Importantly, the fisheye and flip zoom ZUIs are not common, naturally occurring phenomena. The fisheye effect is perhaps best known through the fisheye lens that people can use on cameras when taking photos to magnify the center of the photo in relation to the peripheries. However, this effect only occurs in nature when looking through a water droplet or into a fishbowl. These are certainly not methods that humans innately use to gain more information about a particular object of interest. The flip zoom does not resemble any aspect of the real world at all, making it difficult for people to feel comfortable and natural when using a flip zoom ZUI. This unnatural feeling can be disconcerting and creates cognitive friction and disconnect, where people are always keenly aware of the animation in the fisheye and flip zoom ZUIs and may never feel truly comfortable when interacting with objects in those interfaces.

### BRIEF SUMMARY

The present disclosure contemplates various devices and methods for overcoming the above drawbacks associated with the related art. One aspect of the embodiments of the present disclosure is a computer program product comprising one or more non-transitory program storage media on which are stored instructions executable by one or more processors or programmable circuits to perform operations for performing a magnification operation in relation to an object displayed on a graphical user interface. The operations may comprise receiving a user selection of an object displayed on a graphical user interface, determining an initial set of spatial dimensions of the selected object, determining an initial set of spatial dimensions of one or more non-selected objects displayed on the graphical user interface, determining a set of spatial dimensions of a viewing window of the graphical user interface, and, in response to the user selection, positioning the selected object in a center of the viewing window, calculating a final set of spatial dimensions of the selected object based on the set of spatial dimensions of the viewing window, and calculating a final set of spatial dimensions of the one or more non-selected objects based on the initial set of spatial dimensions of the selected object, the final set of spatial dimensions of the selected object, and the initial set of spatial dimensions of the one or more non-selected objects. The operations may further comprise transforming the selected object according to the calculated final set of spatial dimensions of the selected object and transforming the one or more non-selected objects according to the calculated final set of spatial dimensions of the one or more non-selected objects.

Each of the sets of spatial dimensions may include a first spatial dimension defining a length parallel to a first axis and a second spatial dimension defining a length parallel to a second axis. The calculating of the final set of spatial dimensions of the one or more non-selected objects may include calculating the final first spatial dimension of the one or more non-selected objects based on the initial first spatial dimension of the selected object, the final first spatial dimension of the selected object, and the initial first spatial dimension of the one or more non-selected objects, irrespective of the initial second spatial dimension of the selected object, the final second spatial dimension of the selected object, and the initial second spatial dimension of the one or more non-selected objects. The calculating of the final set of spatial dimensions of the one or more non-selected objects may further include calculating the final second spatial dimension of the one or more non-selected objects based on the initial second spatial dimension of the selected object, the final second spatial dimension of the selected object, and the initial second spatial dimension of the one or more non-selected objects, irrespective of the initial first spatial dimension of the selected object, the final first spatial dimension of the selected object, and the initial first spatial dimension of the one or more non-selected objects. The calculating of the final first spatial dimension of the one or more non-selected objects may include computing a first ratio of the final first spatial dimension of the selected object to the initial first spatial dimension of the selected object and scaling the initial first spatial dimension of the one or more non-selected objects according to the computed first ratio. The calculating of the final second spatial dimension of the one or more non-selected objects may include computing a second ratio of the final second spatial dimension of the selected object to the initial second spatial dimension of the selected object and scaling the initial second spatial dimension of the one or more non-selected objects according to the computed second ratio. The calculating of the final first and second spatial dimensions of the selected object may include subtracting a predetermined margin from one or both of the first and second spatial dimensions of the viewing window.

The transforming of the selected object may include displaying an animation of the selected object from the initial set of spatial dimensions of the selected object to the final set of spatial dimensions of the selected object. The transforming of the one or more non-selected objects may include displaying an animation of the one or more non-selected objects from the initial set of spatial dimensions of the one or more non-selected objects to the final set of spatial dimensions of the one or more non-selected objects.

The initial set of spatial dimensions of the selected object may define a rectangle, and the final set of spatial dimensions of the selected object may define a non-rectangle. The transforming of the selected object may include displaying an animation of the selected object deforming from the rectangle to the non-rectangle.

The final set of spatial dimensions of the selected object may define a rectangle, and the initial set of spatial dimensions of the selected object may define a non-rectangle. The transforming of the selected object may include displaying an animation of the selected object deforming from the non-rectangle to the rectangle.

The operations may comprise determining an initial position of each of the one or more non-selected objects and calculating a final position of each of the one or more non-selected objects based on the initial set of spatial dimensions of the selected object, the final set of spatial dimensions of the selected object, and the initial position of the non-selected object. The operations may comprise positioning each of the one or more non-selected objects according to the calculated final position of the non-selected object. Each of the sets of spatial dimensions may include a first spatial dimension defining a length parallel to a first axis and a second spatial dimension defining a length parallel to a second axis. The initial positions of each of the one or more non-selected objects may include a first component along the first axis and a second component along the second axis. The calculating of the final position of each of the one or more non-selected objects may include computing a first ratio of the final first spatial dimension of the selected object to the initial first spatial dimension of the selected object, scaling the first component of the initial position of the non-selected object according to the computed first ratio, computing a second ratio of the final second spatial dimension of the selected object to the initial second spatial dimension of the selected object, and scaling the second component of the initial position of the non-selected object according to the computed second ratio.

The operations may comprise, after the transforming of the selected object and after the transforming of the one or more non-selected objects, receiving a navigation command newly selecting an object from among the one or more non-selected objects in place of the previously selected object. The operations may comprise, in response to the navigation command, positioning the newly selected object in the center of the viewing window, calculating a new set of spatial dimensions of the newly selected object based on the set of spatial dimensions of the viewing window, and calculating a new set of spatial dimensions of the previously selected object based on the initial set of spatial dimensions of the newly selected object, the new set of spatial dimensions of the newly selected object, and the initial set of spatial dimensions of the previously selected object. The operations may comprise transforming the newly selected object according to the calculated new set of spatial dimensions of the newly selected object and transforming the previously selected object according to the calculated new set of spatial dimensions of the previously selected object. The navigation command may comprise a drag command positioning the newly selected object within a predetermined distance from the center of the viewing window.

The selected object may comprise a container containing a visual representation of data in two or more data layers corresponding to magnification states of the container. A layout of the visual representation of data in at least one of the two or more data layers may responsively adjust to the transforming of the selected object.

Another aspect of the embodiments of the present disclosure is a mobile device comprising the above computer program product. The viewing window may be at least a portion of a display screen of the mobile device.

Another aspect of the embodiments of the present disclosure is a server comprising the above computer program product. The viewing window may be at least a portion of a display area of a web browser or other application installed on a remote device.

Another aspect of the embodiments of the present disclosure is a method of performing a magnification operation in relation to an object displayed on a graphical user interface. The method may comprise receiving a user selection of an object displayed on a graphical user interface, determining an initial set of spatial dimensions of the selected object, determining an initial set of spatial dimensions of one or more non-selected objects displayed on the graphical user interface, determining a set of spatial dimensions of a viewing window of the graphical user interface, and, in response to the user selection, positioning the selected object in a center of the viewing window, calculating a final set of spatial dimensions of the selected object based on the set of spatial dimensions of the viewing window, and calculating a final set of spatial dimensions of the one or more non-selected objects based on the initial set of spatial dimensions of the selected object, the final set of spatial dimensions of the selected object, and the initial set of spatial dimensions of the one or more non-selected objects. The method may further comprise transforming the selected object according to the calculated final set of spatial dimensions of the selected object and transforming the one or more non-selected objects according to the calculated final set of spatial dimensions of the one or more non-selected objects.

Another aspect of the embodiments of the present disclosure is a system for performing a magnification operation in relation to an object displayed on a graphical user interface. The system may comprise a first electronic device with a display screen supporting a first viewing window having a set of spatial dimensions, an object data input interface for receiving a user selection of an object displayed on a graphical user interface, determining an initial set of spatial dimensions of the selected object, and determining an initial set of spatial dimensions of one or more non-selected objects displayed on the graphical user interface, and a viewing window data input interface for determining the set of spatial dimensions of the first viewing window. The system may further comprise a magnification engine that, in response to receiving the user selection from the first electronic device, positions the selected object in a center of the first viewing window, calculates a final set of spatial dimensions of the selected object based on the set of spatial dimensions of the first viewing window, and calculates a final set of spatial dimensions of the one or more non-selected objects based on the initial set of spatial dimensions of the selected object, the final set of spatial dimensions of the selected object, and the initial set of spatial dimensions of the one or more non-selected objects. The magnification engine may transform the selected object according to the calculated final set of spatial dimensions of the selected object and transform the one or more non-selected objects according to the calculated final set of spatial dimensions of the one or more non-selected objects.

The system may comprise a second electronic device with a display screen supporting a second viewing window having a set of spatial dimensions different from the set of spatial dimensions of the first viewing window. The viewing window data input interface may determine the set of spatial dimensions of the second viewing window. The magnification engine may, in response to receiving the user selection from the second electronic device, position the selected object in a center of the second viewing window, calculate a final set of spatial dimensions of the selected object based on the set of spatial dimensions of the second viewing window, and calculate a final set of spatial dimensions of the one or more non-selected objects based on the initial set of spatial dimensions of the selected object, the final set of spatial dimensions of the selected object, and the initial set of spatial dimensions of the one or more non-selected objects.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 shows a system for performing a magnification operation according to an embodiment of the present disclosure;

FIG. 2 shows a zoom animation in relation to an object displayed on a graphical user interface;

FIG. 3 shows another zoom animation in relation to an object displayed on a graphical user interface;

FIG. 4 shows another zoom animation in relation to an object displayed on a graphical user interface, where portions of objects that grow to extend outside the viewing window are also shown;

FIG. 5 shows another zoom animation in relation to an object displayed on a graphical user interface, where non-selected objects are repositioned according to the magnification operation;

FIG. 6A shows a group of objects displayed on a graphical user interface prior to the magnification operation;

FIG. 6B shows a magnification operation in relation to the group of objects of FIG. 6A;

FIGS. 7A and 7B show a zoom animation in relation to a rectangular object on a graphical user interface whose shape is changed by the magnification operation, with FIG. 7A showing a three-dimensional perspective view and FIG. 7B showing a two-dimensional x-y plane view;

FIGS. 8A and 8B show a zoom animation in relation to a circular object on a graphical user interface whose shape is changed by the magnification operation, with FIG. 8A showing a three-dimensional perspective view and FIG. 8B showing a two-dimensional x-y plane view;

FIG. 9 shows an example graphical user interface in a magnified state, with objects outside of the viewing window also shown together with navigation directions for moving the view to non-visible areas;

FIGS. 10A and 10B show another example graphical user interface in different magnification states in the context of a specific application within a multi-timeline and phase interface, with FIG. 10A showing an unmagnified state and FIG. 8B showing a magnified state;

FIG. 11A is a schematic diagram depicting a user interaction with a graphical user interface (left-hand side) and a resulting surface navigation (right-hand side) in relation to a plurality of objects displayed on a graphical user interface in a magnified state;

FIG. 11B is a schematic diagram depicting another user interaction with a graphical user interface (left-hand side) and a resulting surface navigation (right-hand side) in relation to a plurality of objects displayed on a graphical user interface in a magnified state;

FIG. 11C is a schematic diagram depicting another user interaction with a graphical user interface (left-hand side) and a resulting surface navigation (right-hand side) in relation to a plurality of objects displayed on a graphical user interface in a magnified state;

FIG. 11D is a schematic diagram depicting another user interaction with a graphical user interface (left-hand side) and a resulting surface navigation (right-hand side) in relation to a plurality of objects displayed on a graphical user interface in a magnified state;

FIG. 12 shows an example operational flow for performing a magnification operation according to an embodiment of the present disclosure;

FIG. 13 shows an example subprocess of step 1250 in FIG. 12; and

FIG. 14 shows an example subprocess of step 1260 in FIG. 12.

### DETAILED DESCRIPTION

The present disclosure encompasses various embodiments of systems and methods for performing a magnification operation in relation to an object displayed on a graphical user interface. The described magnification operation (which may sometimes be referred to as a zoom operation) may be regarded as defining a new type of semantic ZUI that may be referred to herein as an Elastic Zoomable User Interface (EZUI), which may be a core infrastructure piece of a software product, for example. The detailed description set forth below in connection with the appended drawings is intended as a description of several currently contemplated embodiments and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

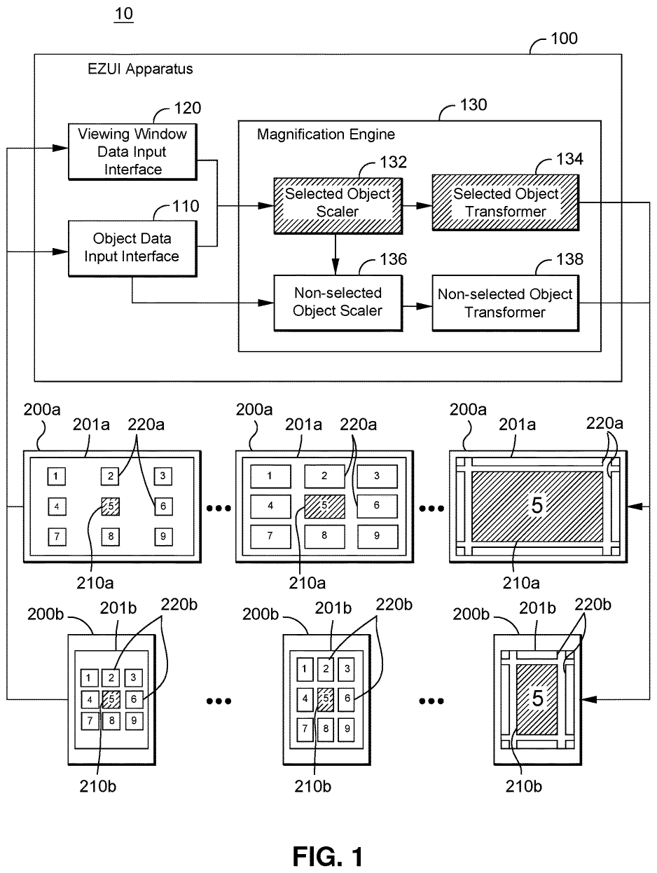

FIG. 1 shows a system 10 for performing a magnification operation according to an embodiment of the present disclosure. An Elastic Zoomable User Interface (EZUI) apparatus 100, which may be embodied in a computer program product as described in more detail below, may reside within or otherwise communicate with an electronic device 200a, 200b (generically referred to as an electronic device 200). Two example electronic devices 200a, 200b are shown in FIG. 1, each having a display screen on which a graphical user interface is displayed. In the illustrated example, the display screen of the first electronic device 200a supports a viewing window 201a of the graphical user interface (sometimes referred to as a viewport) having a set of spatial dimensions (e.g. width x and height y) defining an aspect ratio that might be typical of a laptop or desktop computer or a tablet, while the display screen of the second electronic device 200b supports a viewing window 201b having a different set of spatial dimensions as may be typical of a smartphone, for example. Viewing windows 201a, 201b may generically be referred to as viewing windows 201. The types of electronic devices 200 that may be used with the system 10 are not intended to be limited by these examples and may include electronic devices 200 having other aspect ratios as well as non-rectangular display screens and viewing windows 201 with differently defined sets of spatial dimensions, such as in the case of a smartwatch, for example. It should also be noted that, in the context of a windowed application or web browser running on an electronic device 200, the supported viewing windows 201 described and depicted herein may differ from the physical dimensions of the display screen as they may be arbitrarily sized within the bounds of the display screen.

By virtue of the EZUI apparatus 100, an electronic device 200 may present a graphical user interface to a user (e.g. over a web browser or other application) that functions as an Elastic Zoomable User Interface (EZUI) as described herein. A user of an electronic device 200 may interact with an object displayed on the graphical user interface to magnify the object (sometimes referred to as zooming in on the object) in order to focus more closely on the object and/or reveal one or more additional data layers, for example. Unlike conventional ZUIs, the EZUI enabled by the EZUI apparatus 100 may take into consideration the spatial dimensions of the viewing window 201 of the graphical user interface, flexibly transforming the object to take advantage of the display screen capabilities of the particular electronic device 200 while transforming surrounding objects accordingly in order to create a natural and intuitive magnification effect. To this end, the EZUI apparatus 100 may include an object data input interface 110, a viewing window data input interface 120, and a magnification engine 130 as shown in FIG. 1.

Referring by way of example to the viewing window 201a of the electronic device 200a shown in FIG. 1 (but equally applying to other viewing windows 201 of other electronic devices 200), the object data input interface 110 may receive a user selection of an object 210a displayed in the viewing window 201a of the graphical user interface (e.g. object number 5 in FIG. 1). The user may select the object 210a by any user-device input modality, such as tapping on a touchscreen or clicking with a mouse, for example. The object data input interface 110 may determine an initial set of spatial dimensions of the selected object 210a (i.e. dimensions prior to the magnification operation). The initial set of spatial dimensions may be determined in advance, such as when the object 210a initially appears in the viewing window 201a, or in response to the user's selection. In FIG. 1, the initial spatial dimensions of the selected object 210a corresponding to the unmagnified state of the graphical user interface are represented by the left-most view of the viewing window 201a.

In the case of a rectangular (e.g. square) object 210a like object number 5 in FIG. 1, the set of spatial dimensions may include a first spatial dimension defining a length parallel to a first axis (e.g. a width parallel to an x axis) and a second spatial dimension defining a length parallel to a second axis (e.g. a height parallel to a y axis), with the lengths measured in pixels for example. The first and second axes may typically be orthogonal, such as in the case of a width and a height, but this is not necessarily the case. More generally, the set of spatial dimensions may include any number of spatial dimensions that provide information about the spatial extent (e.g. size, shape) of the object 210a in the viewing window 201a. For example, in the case of elliptical or arbitrarily shaped objects, the first and second spatial dimensions may define lengths or other measures in relation to foci, vertices, radii, perimeters, or any other geometric reference points of the objects.

The object data input interface 110 may likewise determine an initial set of spatial dimensions of one or more non-selected objects 220a displayed on the graphical user interface (e.g. objects numbers 1-4 and 6-9 in FIG. 1). For example, the object data input interface 110 may determine the initial set of spatial dimensions of all non-selected objects 220a that are in the viewing window 201a at the time of the user's selection.

The viewing window data input interface 120 may determine the set of spatial dimensions of the viewing window 201a containing the objects 210a, 220a. As in the case of the spatial dimensions of the objects, the set of spatial dimensions of the viewing window 201a may include a first spatial dimension defining a length parallel to the same first axis (e.g. x axis) and a second spatial dimension defining a length parallel to the same second axis (e.g. y axis), as in the case of a rectangular viewing window 201a as shown in FIG. 1. More generally, the set of spatial dimensions of the viewing window 201 may include any number of spatial dimensions that provide information about the spatial extent (e.g. size, shape) of the viewing window 201. In the case of a smart watch, for example, the set of spatial dimensions may define a circular or elliptical viewing window 201 corresponding to the shape of the display screen of the electronic device 200.

The magnification engine 130 may receive the user selection of the object 210a from the electronic device 200a along with the various spatial dimensions output by the object data input interface 110 and viewing window data input interface 120. In response to receiving the user selection, the magnification engine 130 may execute the magnification operation described herein that is characteristic of the EZUI, resulting in the magnified (or zoomed in) state of the graphical user interface represented by the right-most view of the viewing window 201a in FIG. 1.

In particular, a selected object scaler 132 of the magnification engine 130 may calculate a final (magnified) set of spatial dimensions of the selected object 210a based on the set of spatial dimensions of the viewing window 201a. A selected object transformer 134 of the magnification engine 130 may then transform the selected object 210a according to the calculated final set of spatial dimensions of the selected object 210a, which may include displaying an animation of the selected object 210a from the initial set of spatial dimensions of the selected object 210a as depicted in the left-most view of the viewing window 201a to the final set of spatial dimensions of the selected object 210a as depicted in the right-most view of the viewing window 201a. The transition may happen smoothly (e.g. at more than 30 fps, preferably at least 60 fps), with the viewing window 201a in the center of FIG. 1 representing one intermediate frame of the animation.

With the final dimensions of the selected object 210a having been calculated, the magnification engine 130 may further calculate final (magnified) dimensions of the one or more non-selected objects 220a. In this regard, a non-selected object scaler 136 of the magnification engine 130 may calculate a final set of spatial dimensions of the one or more non-selected objects 220a based on the initial set of spatial dimensions of the selected object 210a, the calculated final set of spatial dimensions of the selected object 210a, and the initial set of spatial dimensions of the one or more non-selected objects 220a. A non-selected object transformer 138 of the magnification engine 130 may then transform the one or more non-selected objects 220a according to the calculated final set of spatial dimensions of the one or more non-selected objects 220a, which may likewise include displaying an animation of the one or more non-selected objects 220a from the initial set of spatial dimensions of the one or more non-selected objects 220a to the final set of spatial dimensions of the one or more non-selected objects 220a (as depicted from left to right in FIG. 1).

In the case of the electronic device 200b having the viewing window 201b, the EZUI apparatus 100 may execute the magnification operation in the same way in relation to the selected object 210b and non-selected objects 220b. In this regard, the selected object 210a, 210b may generically be referred to as a selected object 210, and the non-selected object(s) 220a, 220b may generically being referred to as non-selected object(s) 220. As illustrated, even though all of the selected and non-selected object 210, 220 initially have the same size and shape as shown in the left-hand side of FIG. 1, the selected object 220b and non-selected object 220b are magnified differently (elongated vertically) due to the different aspect ratio of the viewing window 201b.

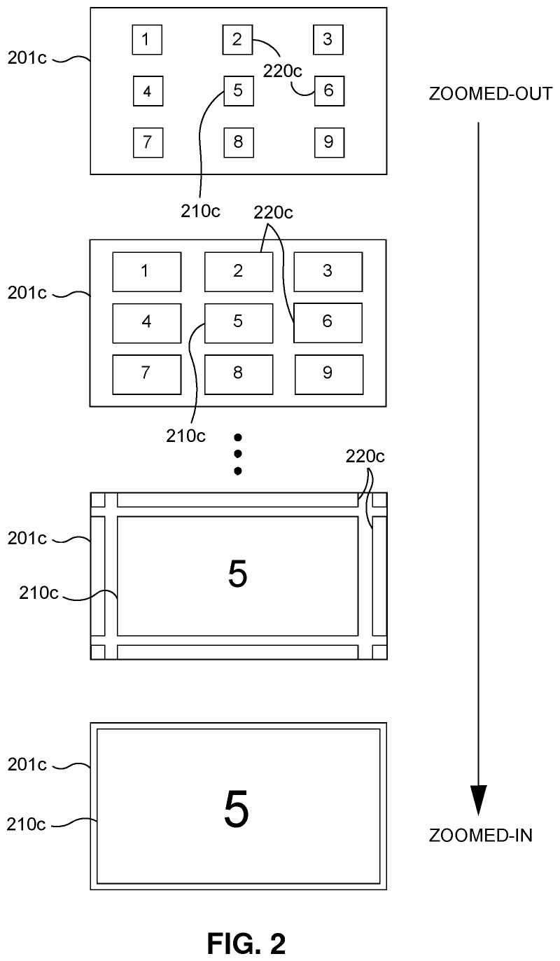

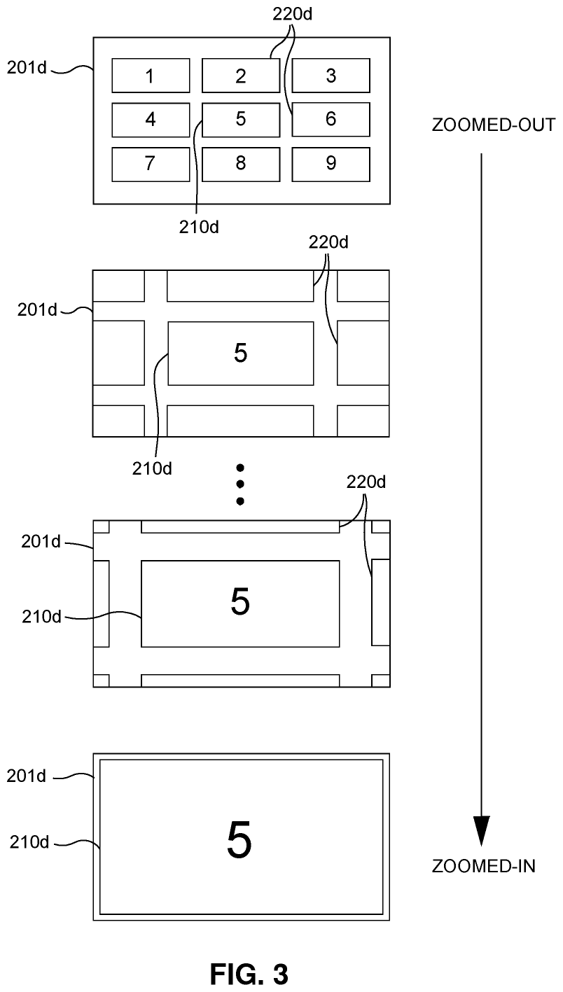

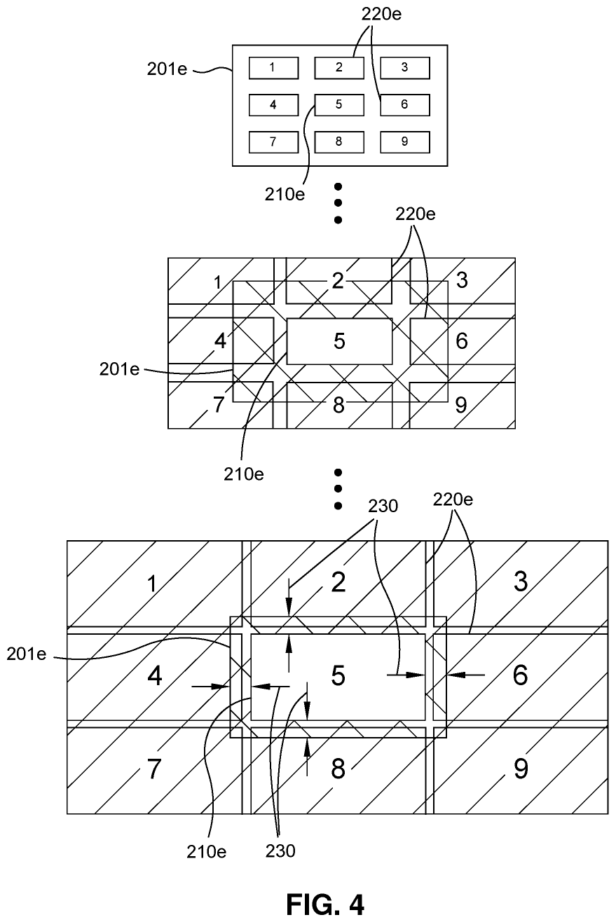

FIGS. 2 and 3 show zoom animations in relation to an object 210c, 210d displayed on a graphical user interface of an electronic device 200c, 200d. FIG. 4 shows another zoom animation in relation to an object 210e displayed on a graphical user interface of an electronic device 200e. The electronic devices 200c, 200d, 200e are further examples of an electronic device 200 as described above, with the viewing windows 201c, 201d, 201e, selected objects 210c, 210d, 210e, and non-selected objects 220c, 220d, 220e being further examples of the viewing window 201, selected object 210, and non-selected object(s) 220 of the disclosed EZUI. FIGS. 2 and 3 differ from each other in the initial set of spatial dimensions of the selected and non-selected objects 210, 220. In particular, in FIG. 2, the objects 210c, 220c are initially square (similar to the examples of FIG. 1), whereas, in FIG. 3, the objects 210d, 220d initially have greater width x than height y and match the aspect ratio of the viewing window 201d. In this case, the aspect ratios may not need adjustment as part of the magnification operation, as only the sizes and not the shapes are changed. FIG. 4 differs from FIG. 3 in that it shows the scaling of the non-selected objects 220e even outside the viewing window 201e (i.e. elsewhere on the canvas). Note that the region outside the viewing window 201e cannot be seen by a user of the electronic device 200e (unless the user navigates away from the selected object 210e in the x-y plane as described in more detail below) but is included in FIG. 4 for the purpose of explanation. FIG. 4 also differs from FIG. 3 in that the lowermost (final) frame of the animation leaves more room between the selected object 210e and the border of the viewing window 201e (making it equivalent to the third of the four frames in FIG. 3). This results in one or more margins 230 around the fully zoomed-in object 210e as shown, which may include top, right, bottom, and left margins 230, for example.

As explained above in relation to FIG. 1, the selected object scaler 132 of the magnification engine 130 may calculate a final (magnified) set of spatial dimensions of the selected object 210 based on the set of spatial dimensions of the viewing window 201. In the case of the selected object 210c of FIG. 2, which initially has a different aspect ratio than the viewing windows 201c, the selected object scaler 132 may calculate the final set of spatial dimensions of the selected object 210c to match the aspect ratio and size of the viewing window 201c (or, more generally, to match the shape and size of the viewing window 201). As can be seen, the lowermost (final) frame of the animations shown in FIGS. 2 and 3 has only the selected object 210 visible because it takes up the entire viewing window 201 (minus a predetermined margin as described in more detail below). None of the non-selected objects 220 remain visible, and the user's attention can be focused on the selected object 210 without distraction. Moreover, unlike a conventional geometric zoom, which proportionally magnifies all areas of the graphical user interface (including blank space), the EZUI magnification operation shown in FIGS. 2-4 disproportionally magnifies objects 210, 220 in accordance with the viewing window 201. As such, the initially square selected object 210c has been made to fit in the non-square viewing window 201c without wasted space on the left and right sides and without being cut off on the top and bottom.

The calculation of the final set of spatial dimensions of the selected object 210 by the selected object scaler 132 may account for a predetermined margin 230 (see FIG. 4). For example, in the above case where each of the sets of spatial dimensions includes a first spatial dimension defining a length parallel to a first axis and a second spatial dimension defining a length parallel to a second axis (e.g. a width x and a height y), the calculation of the final first and second spatial dimensions of the selected object 210 may include subtracting a predetermined margin 230 from one or both of the first and second spatial dimensions of the viewing window 210. In the case of a rectangular viewing window 210, margins 230 may include separately definable top, right, bottom, and left margins 230, which may be given predetermined values by a developer of the graphical user interface or by a user, for example. When the user's view is zoomed in on the selected object 210 (i.e. when the selected object 210 is magnified), the margins 230 may provide the user with some context as parts of the peripheral non-selected objects 220 may be visible for easier orientation and navigation or for design or aesthetic purposes. By way of contrast, the lowermost (final) frames of the animations depicted in FIGS. 2 and 3 do not include significant margins 230, only including nominal margins 230 (reference numbers omitted) to allow the border of the selected object 210c, 210d to be visible. It is also contemplated that the final state of the EZUI magnification operation may leave no margins 230 at all, in which case the selected object 210 may exactly match the size and shape of the viewing window 201.

In addition to scaling the selected object 210, the magnification engine 130 of the EZUI apparatus 100 may further scale one or more non-selected objects 220 as mentioned above. In this regard, as noted above, the non-selected object scaler 136 of the magnification engine 130 may calculate a final set of spatial dimensions of a given non-selected object 220 based on the initial set of spatial dimensions of the selected object 210, the calculated final set of spatial dimensions of the selected object 210, and the initial set of spatial dimensions of the non-selected object 220 in question. In particular, the non-selected object(s) 220 may be scaled in a way that is proportional to the scaling of the selected object 210. This can be seen in FIGS. 2-4, where each of the non-selected object(s) 220 (objects 1-4 and 6-9) begins with the same initial set of spatial dimensions as the selected object 210 (object 5) and thus grows to the same final set of spatial dimensions as the selected object 210. In the case of non-selected object(s) 220 that are initially smaller or larger than the selected object 210, the final dimensions of the non-selected object(s) 220 may likewise be smaller or larger than the selected object 210.

In order to proportionally scale the non-selected object(s) 220 in the case of first and second spatial dimensions as described above, the first and second spatial dimensions of the non-selected object(s) 220 (e.g. x and y dimensions in the case of a rectangle) may be scaled independently of each other, i.e. using dual scale factors rather than a single scale factor. By way of example, the calculation of the final first spatial dimension (e.g. width x) of a given non-selected object 220 by the non-selected object scaler 136 may be based on the initial first spatial dimension of the selected object 210, the final first spatial dimension of the selected object 210, and the initial first spatial dimension of the non-selected object 220 in question, irrespective of the initial second spatial dimension of the selected object 210, the final second spatial dimension of the selected object 210, and the initial second spatial dimension of the given non-selected object 220. Likewise, the calculation of the final second spatial dimension (e.g. height y) of a given non-selected object 220 by the non-selected object scaler 136 may be based on the initial second spatial dimension of the selected object 210, the final second spatial dimension of the selected object 210, and the initial second spatial dimension of the non-selected object 220 in question, irrespective of the initial first spatial dimension of the selected object 210, the final second first spatial dimension of the selected object 210, and the initial first spatial dimension of the given non-selected object 220. That is, the final width x of the non-selected object 220 may be determined based only on the initial and final widths x and not on the heights y of the objects 210, 220, while the final height y of the non-selected object 220 may be determined based only on the initial and final heights y and not on the widths x of the objects 210, 220.

The calculation may be performed as follows. First, the non-selected object scaler 136 may compute a first ratio of the final first spatial dimension of the selected object 210 to the initial first spatial dimension of the selected object 210. This first ratio may be used as a first scale factor for all of the objects 210, 220, e.g. a horizontal scale factor in a case where the first spatial dimension is a width x. The non-selected object scaler 136 may also compute a second ratio of the final second spatial dimension of the selected object 210 to the initial second spatial dimension of the selected object 210. This second ratio may be used as a second scale factor for all of the objects 210, 220, e.g. a vertical scale factor in a case where the second spatial dimension is a height y. The non-selected object scaler 136 may then scale the initial first spatial dimension of each non-selected object 220 according to the computed first ratio and scale the initial second spatial dimension of each non-selected object 220 according to the computed second ratio, for example, by multiplying the initial first spatial dimension by the first ratio and multiplying the initial second spatial dimension by the second ratio.

In addition to scaling the selected object 210 and non-selected object(s) 220 as described above, the magnification engine 130 may also position the selected object 210 in the center of the viewing window 201 (e.g. by moving a viewport corresponding to the viewing window 201 relative to a canvas). For example, upon the user selection of the selected object 210, the magnification engine may translate the entire set of objects 210, 220 on the graphical user interface in the x-y plane until the selected object 210 is in the center of the viewing window 201, translating all of the other objects 220 by the same amount. The magnification engine 130 can position the selected object 210 in the beginning of the magnification operation before scaling the objects 210, 220. Alternatively, the magnification engine 130 can move the selected object 210 toward the center of the viewing window 201 gradually (e.g. by moving the viewport), together with the scaling of the objects 210, 220. In this case, final x-y positions of the objects 210, 220 may be determined from the initial x-y positions of the objects 210, 220, and the transition from the initial to final positions may be smoothly animated together with the scaling from the initial to final spatial dimensions.

As can be seen in FIGS. 2-4, one of the ways in which the disclosed EZUI magnification operation may differ from a conventional geometric zoom is in the treatment of blank space. Because, in the above examples, the EZUI magnification operation transforms only a set of objects 210, 220 on the graphical user interface and not all portions of the graphical user interface (as in the case of a geometric zoom on an image, for example), the blank space between objects 210, 220 may be deemphasized and become smaller as the zoom animation progresses. In this way, the EZUI magnification operation described herein may help to focus a user on important information. At the same time, unlike existing semantic ZUIs like flip zoom ZUIs, the magnification operation is still intuitive and natural feeling as it proportionally scales the non-selected objects 220, simulating the appearance of moving closer to a scene to get a closer look without the wasted space of a geometric zoom.

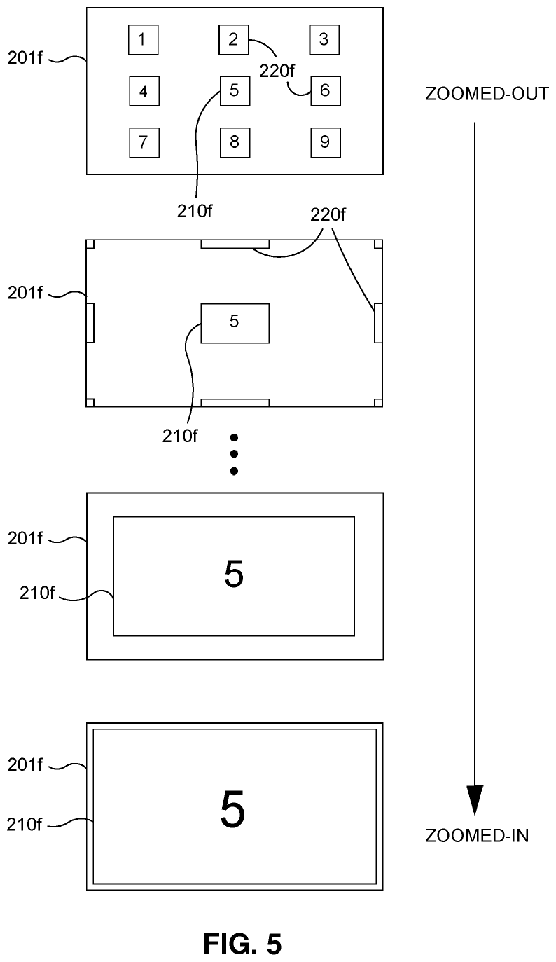

It is contemplated, however, that the relative positions of the non-selected object(s) 220 may be altered by the magnification operation in order to maintain or increase the amount of blank space between the objects 210, 220. An example of this is shown in FIG. 5, where the blank space between the selected object 210f and the non-selected objects 220f (and the blank space between the non-selected objects 220f) expands as part of the magnification operation. To this end, the object data input interface 110 of the EZUI apparatus 100 may further determine an initial position of each non-selected object 220 as well as an initial position of the selected object 210. The zoom engine 130 may then reposition all of the objects 210, 220 taking into consideration the scaling of the selected object 210 of the magnification operation (which depends on its initial dimensions and the dimensions of the viewing window 201 as described above). For example, the non-selected object scaler 136 of the zoom engine 130 may, in addition to calculating the final spatial dimensions of the non-selected object(s) 220, calculate a final position of each non-selected object based on the initial set of spatial dimensions of the selected object 210, the final set of spatial dimensions of the selected object 210, and the initial position of the non-selected object 220. The selected object scaler 132 may similarly calculate a final position of the selected object 210 based on the initial set of spatial dimensions of the selected object 210, the final set of spatial dimensions of the selected object 210, and the initial position of the selected object 210. The non-selected object transformer 138 may then position each of the non-selected objects 220 according to the calculated final position of the non-selected object 220, and the selected object transformer 134 may likewise position the selected object according to the calculated final position of the selected object 210. The positioning of the objects 210, 220 in this way may be defined relative to the canvas rather than the viewing window 201. Thus, the positions may establish relative spacing between the objects 210, 220, rather than absolute position from the perspective of the user. When the magnification operation positions the selected object 210 in the center of the viewing window 201 (e.g. by moving the viewport relative to the canvas), these relative positions between the objects 210, 220 may be maintained.

In the case of rectangular objects 210, 220 as described above, the initial positions of each object 210, 220 may include a first component along the first axis (e.g. an x component) and a second component along the second axis (e.g. a y component). In this case, the calculating of the final position of each of the non-selected object(s) 220 may make use of the same first ratio of the final first spatial dimension of the selected object to the initial first spatial dimension of the selected object and second ratio of the final second spatial dimension of the selected object to the initial second spatial dimension of the selected object computed by the selected object scaler 132. The first component of the initial position of each object 210, 220 may be scaled according to the computed first ratio, and the second component of the initial position of each object 210, 220 may be scaled according to the computed second ratio.

As can be seen, since when the positions of the objects 210, 220 are adjusted in accordance with the magnification of the selected object 210 in this way, the objects 210, 220 more rapidly become farther apart as the magnification progresses, effectively expanding the blank space. This may be preferred when the various objects 210, 220 are of varying sizes and might otherwise begin to overlap in some instances as the blank space is diminished (such as where a large non-selected object 220 is adjacent to a smaller selected object 210). By repositioning the objects 210, 220, such overlapping of objects 210, 220 can be avoided.

The following is an exemplary EZUI magnification algorithm that may be performed by the magnification engine 130 in accordance with the above examples:

Step 1: Obtain the values (e.g. in pixels) shown in the following Table 1.

TABLE 1

| Variable | Variable Name | Description |
|---|---|---|
| V_W | Viewport width | First spatial dimension of viewing |
| | | window 201 |
| V_H | Viewport height | Second spatial dimension of viewing |
| | | window 201 |
| O_S_W | Selected object | Initial first spatial dimension of |
| | width | selected object 210 |
| O_S_H | Selected object | Initial second spatial dimension of |
| | height | selected object 210 |
| M_T | Margin top | Size of top margin 230 |
| M_R | Margin right | Size of right margin 230 |
| M_B | Margin bottom | Size of bottom margin 230 |
| M_L | Margin left | Size of left margin 230 |
| O_NS1_W | First non-selected | Initial first spatial dimension of |
| | object width | first non-selected object 220 |
| O_NS1_H | First non-selected | Initial second spatial dimension of |
| | object height | first non-selected object 220 |
| O_NS2_W | Second non-selected | Initial first spatial dimension of |
| | object width | second non-selected object 220 |
| O_NS2_H | Second non-selected | Initial second spatial dimension of |
| | object height | second non-selected object 220 |
| O_NS3_W | Third non-selected | Initial first spatial dimension of |
| | object width | third non-selected object 220 |
| O_NS3_H | Third non-selected | Initial second spatial dimension of |
| | object height | third non-selected object 220 |
| etc. | | |

Step 2: Calculate the new (final) dimensions of the selected object 210 as shown in the following Table 2.

TABLE 2

| Variable | Variable Name | Description |
|---|---|---|
| O_S_Z_W = | Selected object | Final first spatial dimension |
| V_W − | zoomed width | of selected object 210 |
| (M_L + M_R) | | |
| O_S_Z_H = | Selected object | Final second spatial dimension |
| V_H − | zoomed height | of selected object 210 |
| (M_T + M_B) | | |

Step 3: Calculate the vertical and horizontal scale factors for scaling the non-selected objects 220 as shown in the following Table 3.

TABLE 3

| Variable | Variable Name | Description |
|---|---|---|
| F_S_H = | Horizontal | First ratio of final first |
| O_S_Z_W/O_S_W | scale factor | spatial dimension of selected |
| | | object 210 to initial first |
| | | spatial dimension of selected |
| | | object 210 |
| F_S_V = | Vertical | Second ratio of final second |
| O_S_Z_H/O_S_H | scale factor | spatial dimension of selected |
| | | object 210 to initial second |
| | | spatial dimension of selected |
| | | object 210 |

Step 4: Scale the non-selected objects according to the scale factors as shown in Table 4.

TABLE 4

| | | |
|---|---|---|
| O_NS1_Z_W = | First non-selected | Final first spatial |
| O_NS1_W * | object zoomed width | dimension of first |
| F_S_H | | non-selected object 210 |
| O_NS1_Z_H = | First non-selected | Final second spatial |
| O_NS1_H * | object zoomed height | dimension of first |
| F_S_V | | non-selected object 210 |
| O_NS2_Z_W = | Second non-selected | Final first spatial |
| O_NS2_W * | object zoomed width | dimension of second |
| F_S_H | | non-selected object 210 |
| O_NS2_Z_H = | Second non-selected | Final second spatial |
| O_NS2_H * | object zoomed height | dimension of second |
| F_S_V | | non-selected object 210 |
| O_NS3_Z_W = | Third non-selected | Final first spatial |
| O_NS3_W * | object zoomed width | dimension of third |
| F_S_H | | non-selected object 210 |
| O_NS3_Z_H = | Third non-selected | Final second spatial |
| O_NS3_H * | object zoomed height | dimension of third |
| F_S_V | | non-selected object 210 |
| etc. | | |

In order to position the selected object 210 and non-selected objects 220 according to the scaling of the selected object 210, thus creating the impression that the blank space between the objects 210, 220 is expanding (see FIG. 5), the exemplary algorithm may additionally include the following steps:

Step 5: Obtain the additional values (e.g. in pixels) shown in the following Table 4.

TABLE 5

| Variable | Variable Name | Description |
|---|---|---|
| V_P_L | Viewport position left | Position of top left corner of viewing |
| | | window 201 (i.e. position of viewport |
| | | relative to canvas) along axis of first |
| | | spatial dimension |
| V_P_T | Viewport position top | Position of top left corner of viewing |
| | | window 201 (i.e. position of viewport |
| | | relative to canvas) along axis of second |
| | | spatial dimension |
| O_S_L | x-coordinate of selected object, | Initial position of top left corner of |
| | measured from left | selected object 210 along axis of first |
| | | spatial dimension |
| O_S_T | y-coordinate of selected object, | Initial position of top left corner of |
| | measured from top | selected object 210 along axis of second |
| | | spatial dimension |
| O_NS1_L | x-coordinate of first non-selected | Initial position of top left corner of first |
| | object, measured from left | non-selected object 220 along axis of first |
| | | spatial dimension |
| O_NS1_T | y-coordinate of first non-selected | Initial position of top left corner of first |
| | object, measured from top | non-selected object 220 along axis of |
| | | second spatial dimension |
| O_NS2_L | x-coordinate of second non-selected | Initial position of top left corner of second |
| | object, measured from left | non-selected object 220 along axis of first |
| | | spatial dimension |
| O_NS2_T | y-coordinate of second non-selected | Initial position of top left corner of second |
| | object, measured from top | non-selected object 220 along axis of |
| | | second spatial dimension |
| O_NS3_L | x-coordinate of third non-selected | Initial position of top left corner of third |
| | object, measured from left | non-selected object 220 along axis of first |
| | | spatial dimension |
| O_NS3_T | y-coordinate of third non-selected | Initial position of top left corner of third |
| | object, measured from top | non-selected object 220 along axis of |
| | | second spatial dimension |
| etc. | | |

Step 6: Calculate the new (final) coordinates of the selected object 210 and of each non-selected object 220, defined by the top left corner, as shown in the following Table 5.

TABLE 6

| Variable | Variable Name | Description |
|---|---|---|
| O_S_Z_L = | x-coordinate of selected object, | Final position of top left corner of |
| O_S_L * F_S_H − | measured from left side, after | selected object 210 along axis of |
| V_P_L | zoom | first spatial dimension |
| O_S_Z_T = | y-coordinate of selected object, | Final position of top left corner of |
| O S_T * F_S_V − | measured from top, after zoom | selected object 210 along axis of |
| V_P_T | | second spatial dimension |
| O_NS1_Z_L = | x-coordinate of first non-selected | Final position of top left corner of |
| O_NS1_L * F_S_H − | object, measured from left side, | first non-selected object 210 along |
| V_P_L | after zoom | axis of first spatial dimension |
| O_NS1_Z_T = | y-coordinate of first non-selected | Final position of top left corner of |
| O_NS1_T * F_S_T − | object, measured from top, after | first non-selected object 210 along |
| V_P_T | zoom | axis of second spatial dimension |
| O_NS2_Z_L = | x-coordinate of second non-selected | Final position of top left corner of |
| O_NS2_L * F_S_H − | object, measured from left side, | second non-selected object 210 along |
| V_P_L | after zoom | axis of first spatial dimension |
| O_NS2_Z_T = | y-coordinate of second non-selected | Final position of top left corner of |
| O_NS2_T * F_S_T − | object, measured from top, after | second non-selected object 210 along |
| V_P_T | zoom | axis of second spatial dimension |
| O_NS3_Z_L = | x-coordinate of third non-selected | Final position of top left corner of |
| O_NS3_L * F_S_H − | object, measured from left side, | third non-selected object 210 along |
| V_P_L | after zoom | axis of first spatial dimension |
| O_NS3_Z_T = | y-coordinate of third non-selected | Final position of top left corner of |
| O_NS3_T * F_S_T − | object, measured from top, after | third non-selected object 210 along |
| V_P_T | zoom | axis of second spatial dimension |
| etc. | | |

Step 7: Move the viewport to the selected object 210 in order to center the selected object 210 in the viewing window 201, as shown in the following Table 6.

TABLE 7

| | | |
|---|---|---|
| V_P_L_N = | New viewport | New position of top left corner |
| V_P_L + | x-coordinate, | of viewport (corresponding to |
| O_S_Z_L − | top left | viewing window 201) along |
| (M_L + M_R) | | axis of first spatial dimension |
| V_P_T_N = | New viewport | New position of top left corner |
| V_P_T + | y-coordinate, | of viewport (corresponding to |
| O_S_Z_T − | top left | viewing window 201) along |
| (M_L + M_R) | | axis of second spatial dimension |

With the objects 210, 220 already having been repositioned on the canvas in step 6, the movement of the viewport across the canvas in step 7 may effectively center the selected object 210 in the viewing window 201. Because the centering is accomplished by adjusting the position of the viewport on the canvas, the entire contents of the display including the selected object 210 and non-selected objects 220 are translated together as the selected object 210 is centered. It should be noted that the adjustment of the viewport in step 7 may occur simultaneously with the actual transformation of the objects 210, 220 according to the scale factors calculated in step 3 and the new positions calculated in step 6. Thus, from the user's perspective, the selected object 210 may be magnified while approaching the center of the viewing window 201 while the non-selected objects 220 are simultaneously magnified and moved outward away from the selected object 210.

After the EZUI magnification operation is completed, if the user selects one of the previously non-selected objects 220, the algorithm may begin again from step 1 with the newly selected object now being the selected object 210. In this and any subsequent loops through the algorithm, the new viewport coordinates V_P_L_N and V_P_T_N are used in place of the original coordinates V_P_L and V_P_T, which may no longer be relevant.

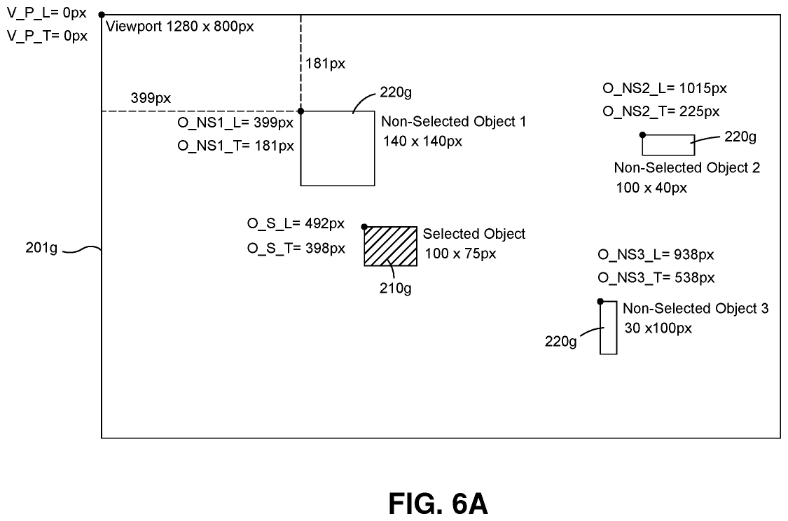

FIG. 6A shows a group of objects 210g, 220g displayed on a graphical user interface prior to the disclosed EZUI magnification operation. As can be seen, the selected object 210g is a 100×75 pixel rectangle and has an initial (x, y) position of 492, 398 measured as the number of pixels to the top left corner, from the left (O_S_L) and from the top (O_S_T), as described in Table 5 above. There are also three non-selected objects 220g numbered 1, 2, and 3, with dimensions and initial positions as shown. The initial position of the viewport on the canvas (corresponding to the viewing window 201g) is defined to be (0, 0). In this example, the objects 210g, 220g are different sizes and shapes and are spaced arbitrarily in order to illustrate the effects of the disclosed EZUI magnification operation.

FIG. 6B shows a magnification operation in relation to the group of objects 210g, 220g of FIG. 6A. In the first frame (top of FIG. 6B), the same state of the graphical user interface is shown as in FIG. 6A. Here, the size is reduced (and the text is removed) in order to accurately portray the relative initial and final states of the magnification operation relative to each other, with this first frame being the initial state. In the second frame (bottom of FIG. 6B), the final state of the magnification operation is shown. As described above, the magnification operation may be accompanied by a zoom animation, though only two frames (initial and final) are shown in this illustration. As can be seen in the second frame (bottom of FIG. 6B), the selected object 210g has now been magnified to the size of the viewing window 201g (minus a small margin). In addition, all of the non-selected objects 220g have been magnified using the same scale factors F_S_H and F_S_V according to the above algorithm (see Table 4, above). Note, for example, that since the selected object 210g has become slightly longer in the horizontal direction (to match the viewing window 201), so too has each of the non-selected objects 220g become slightly longer in the horizontal direction. Also, because each of the objects 210, 220 has been repositioned according to the algorithm (using the same scale factors as described in Table 6, above), the blank space has expanded proportionally and there is no risk of overlap between the selected object 210g and non-selected objects 220g, even though there is a nearby non-selected object 220g (Non-Selected Object 1) that is larger than the selected object 210g.

Lastly, the viewport (corresponding to the viewing window 201g) has been moved to the selected object 210g as described in Table 7, above, in order to center the selected object 210g in the viewing window 201g. This new position of the viewport, which is defined relative to the canvas (large rectangle shown in the bottom image of FIG. 6B housing all of the objects 210g, 220g), may then be on the canvas (large rectangle housing all of the objects 210g, 220g in the second frame of FIG. 6B) may have coordinates V_P_L_N and V_P_T_N as shown, which may be used in place of V_P_L and V_P_T as the algorithm is repeated for the selection of another object.

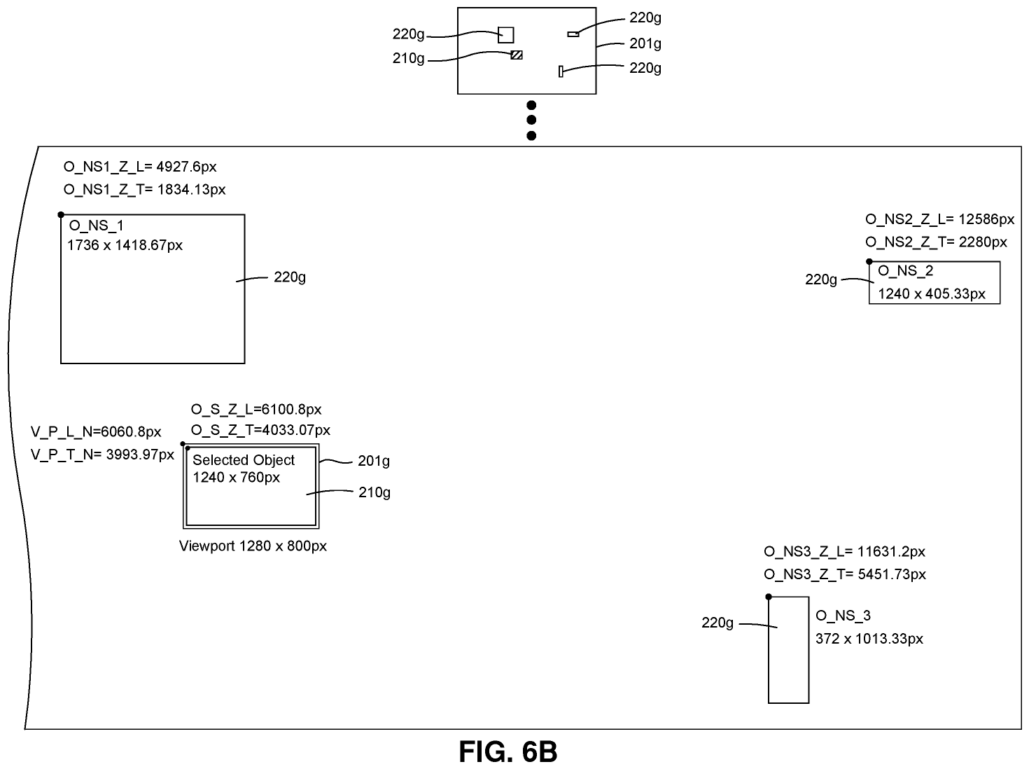

FIGS. 7A and 7B show a zoom animation in relation to a rectangular object 210h in a viewing window 201h of a graphical user interface, with FIG. 7A showing a three-dimensional perspective view and FIG. 7B showing a two-dimensional x-y plane view. The selected object 210h and viewing window 201h are further examples of the selected object 210 and viewing window 201 of the disclosed EZUI magnification operation. In FIGS. 7A and 7B, the magnification operation proceeds from the lowermost (initial) frame to the uppermost (final) frame. FIGS. 7A and 7B illustrate how the selected object 210 may be drastically deformed by the EZUI magnification operation described herein. As shown, the set of spatial dimensions includes first and second spatial dimensions as described above, with the greater of the initial first and second spatial dimensions of the selected object 210h being the height y (see lowermost frame of FIG. 7B), such that the selected object 210h is initially tall and thin. However, after the EZUI operation, the greater of the final first and second spatial dimensions of the selected object 210h is the width x (see uppermost frame of FIG. 7B), such that the selected object 210h has become a wide rectangle matching the viewing window 201h of a typical laptop computer screen. In this way, screen real estate can be efficiently utilized while providing a focused view of an arbitrarily shaped object of interest to the user.

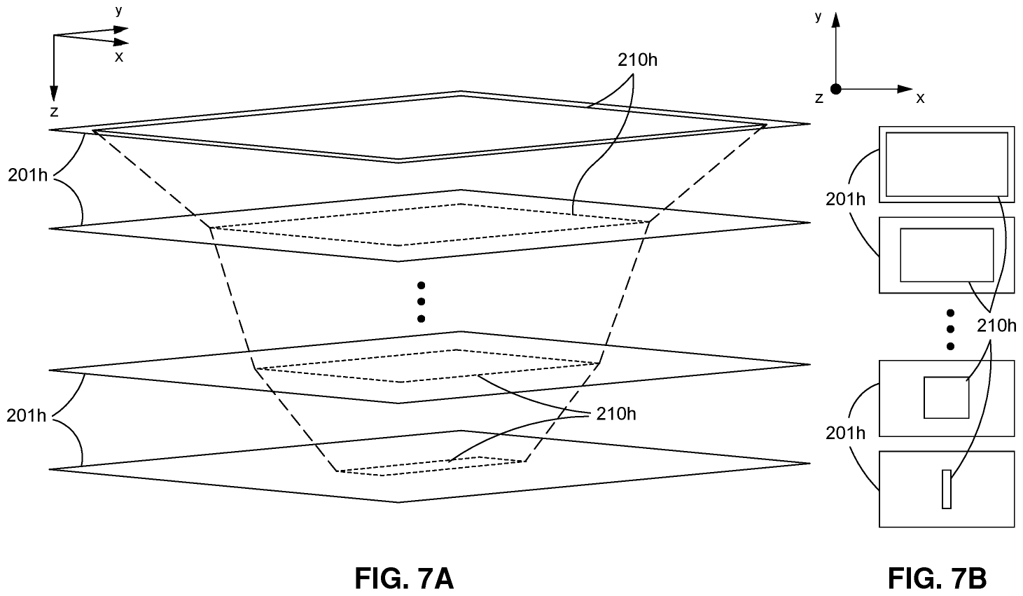

FIGS. 8A and 8B show a zoom animation in relation to a circular object 210i in a viewing window 201i of a graphical user interface, with FIG. 8A showing a three-dimensional perspective view and FIG. 8B showing a two-dimensional x-y plane view. The selected object 210i and viewing window 201i are further examples of the selected object 210 and viewing window 201 of the disclosed EZUI magnification operation. In FIGS. 8A and 8B, like in FIGS. 7A and 7B, the magnification operation proceeds from the lowermost (initial) frame to the uppermost (final) frame. FIGS. 8A and 8B illustrate another way in which the selected object 210 may be drastically deformed by the EZUI magnification operation described herein. In this case, the initial set of spatial dimensions of the selected object 210i define a non-rectangle, specifically a circle. For example, the initial set of spatial dimensions may include a maximum width of the circle in the x direction, a maximum height of the circle in the y direction, and one or more spatial dimensions that define the curvature, eccentricity, circularity, perimeter, etc. of the object 210i. Though the selected object 210i begins as a circle, the EZUI magnification operation may still transform the selected object 210i into a rectangle matching the viewing window 201i of a typical laptop screen as shown in the uppermost frames of FIGS. 8A and 8B. That is, the final set of spatial dimensions of the selected object 210i may define a rectangle (e.g. a width x and a height y).

As represented in the intermediate frames in FIGS. 8A and 8B, the selected object transformer 134 may display an animation of the selected object 210i deforming from the non-rectangle of the lowermost frame to the rectangle of the uppermost frame. The deformation can proceed smoothly (e.g. greater than 30 fps, preferably greater than 60 fps), with the selected object 210i first becoming a rounded square, then a wider rounded rectangle, and finally a rectangle matching the shape of the viewing window 201i. Any non-selected objects 220 may be similarly transformed as described above.

As another example of a selected object 210 or non-selected object 220 changing its shape as part of the EZUI magnification operation, it is contemplated that the initial set of spatial dimensions of the object 210, 220 may define a rectangle while the final set of spatial dimensions of the object 210, 220 defines a non-rectangle such as a circle or ellipse. In this case, the transforming of the selected object 210 or non-selected object 220 may include displaying an animation of the object 210, 220 deforming from the rectangle to the non-rectangle (the opposite of what is shown in FIGS. 8A and 8B, but with the rectangle as the smaller, initial shape). This kind of transformation may be used when the viewing window data input interface 120 of the EZUI apparatus 100 determines there to be a non-rectangular viewing window 201 as may be typical in the case of a smartwatch, for example.

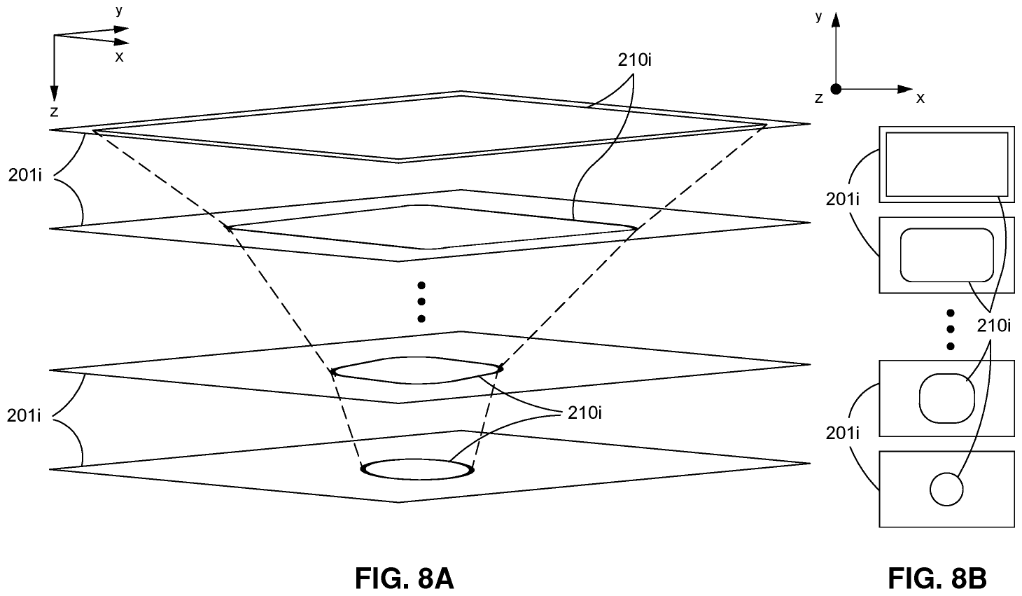

FIG. 9 shows an example graphical user interface in a magnified state. Similar to the example of FIG. 4 and the example frame in the lower part of FIG. 6B, FIG. 9 shows a non-visible region (i.e. canvas) outside of the viewing window 201j that includes the non-selected objects 220j, with the selected object 210j being the sole visible object taking up the entire viewing window 201j. The selected object 210j, non-selected objects 220j, and viewing window 201j are further examples of the selected object 210, non-selected object(s) 220, and viewing window 201 of the disclosed EZUI. As schematically illustrated, the user may navigate in the x-y plane of the viewing window 201j to select one of the non-selected objects 220j. The arrows may indicate possible navigation directions to reveal other objects (object numbers 1-4 and 6-9). Navigating may be possible by panning using any user-device input modality, such as swiping on a touchscreen or clicking and dragging with a mouse, for example. For example, panning diagonally to the top-left corner may reveal object number 1, which may then become the newly selected object 210j.

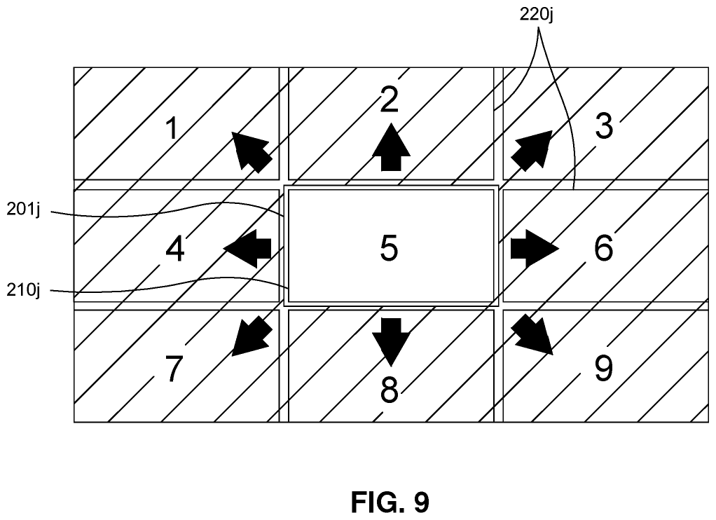

FIGS. 10A and 10B show another example graphical user interface in different zoom states, with FIG. 10A showing a zoomed-out state and FIG. 10B showing a zoomed-in state. In the example of FIGS. 10A and 10B, the graphical user interface is a multi-timeline and phase interface where information related to a project such as hypermedia or code artifacts can be represented with multiple parallel phases or horizontal bar charts. The phases can reside underneath each other or next to each other as well. For example, the graphical user interface may be a timeline-based productivity tool having two magnification levels (data layers): an overview level (FIG. 10A) where all the phases (horizontal bar charts) are visible on the timeline interface, and a detailed view (FIG. 10B) where details about a selected phase are visible. The individual phases are built up by segments, which may cluster temporally relevant and/or organizationally relevant information. These segments can be understood as zoomable objects 210k, 220k in a viewing window 201k of the interface that may be transformed by the EZUI magnification operation. The objects 210k, 220k and viewing window 201k are further examples of the selected object 210, non-selected object(s) 220, and viewing window 201 of the disclosed EZUI magnification operation. Upon performing the magnification operation on a selected object 210k (object number 6), a data layer of the segments may become visible. A segment may contain communications and other interaction between users in the form of notifications, posts, project updates, executable code, etc. including temporally relevant and/or organizationally relevant text and/or multimedia content, for example.

In particular, as shown in FIG. 10B, the selected object 210k (object number 6), which is a segment of an entire phase of this timeline-based interface, has been centered in the viewing window 201k and transformed to fill the viewing window 201k. Depending on the presence of margins 230 (see FIG. 4), other surrounding segments may be partially visible as non-selected objects 220k. As schematically illustrated, the user may navigate in the x-y plane of the viewing window 201k to select one of the non-selected objects 220k. The arrows may indicate possible navigation directions to reveal other objects. In this case, it is contemplated that navigation may be limited to horizontally adjacent objects 220k as shown by the arrows. In order to navigate to another phase (horizontal bar chart) above or below the phase containing the selected object 210k, the user may need to first zoom out. Alternatively, it may be possible for the user to pan in any direction, depending on the particular implementation of the graphical user interface.

In general, it is contemplated that navigating from a selected object 210 to non-selected object 220 while in the zoomed-in state may cause the non-selected object 220 to become a newly selected object 210 replacing the previously selected object 210. For example, after the selected object 210 and one or more non-selected objects 220 are transformed by the user's first selection, the EZUI apparatus 100 may receive a navigation command newly selecting an object from among the one or more non-selected objects 220 in place of the previously selected object 210 (e.g. in accordance with the above algorithm). As described below in more detail, the navigation command may include a drag command positioning the newly selected object within a predetermined distance from the center of the viewing window 201. In response to the navigation command, the zoom engine 130 of the EZUI apparatus 100 may position the newly selected object in the center of the viewing window 201 (e.g. by repositioning the viewport on the canvas as described above), calculate a new set of spatial dimensions of the newly selected object based on the set of spatial dimensions of the viewing window 201, and calculate a new set of spatial dimensions of the previously selected object 210 based on the initial set of spatial dimensions of the newly selected object, the new set of spatial dimensions of the newly selected object, and the initial set of spatial dimensions of the previously selected object 210. The EZUI apparatus 100 may then transform the newly selected object according to the calculated new set of spatial dimensions of the newly selected object and transform the previously selected object 210 according to the calculated new set of spatial dimensions of the previously selected object 210. The scaling of the previously selected object 210 may be proportional to the scaling of the newly selected object as described above. Thus, depending on the size/shape differences between the previously and newly selected objects, the previously selected object 210 may shrink or become even bigger upon the selection of the new object (though the previously selected object 210 will generally not be visible to the user except possibly in a margin 230). The scaling of the newly selected object may likewise cause rescaling of any non-selected objects 220 accordingly, as well as in some cases repositioning the objects 220 as described above.

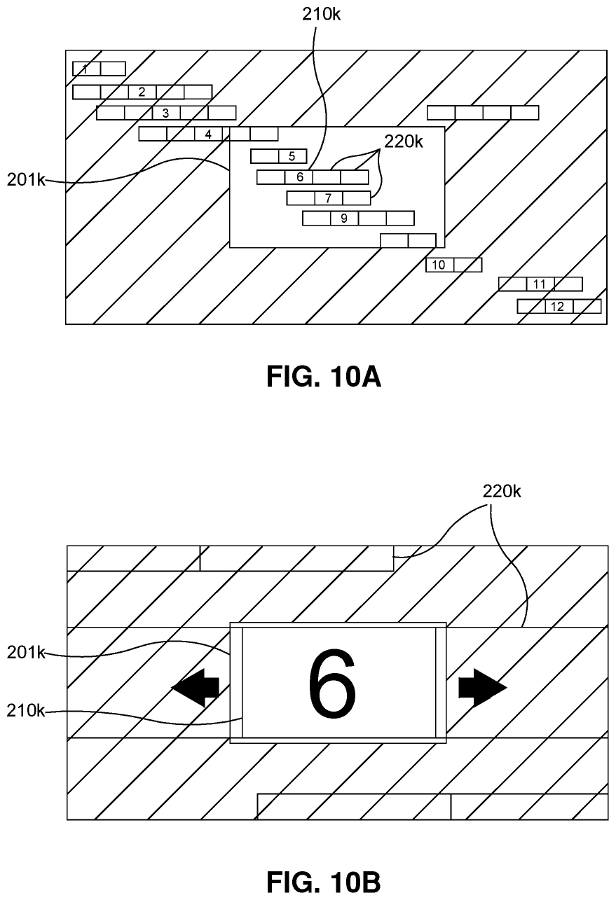

FIGS. 11A-11D are schematic diagrams each depicting a different user interaction with a graphical user interface (left-hand side) and a resulting surface navigation (right-hand side) in relation to a plurality of objects (0, 1, 2, 3, 4, 5) displayed on a graphical user interface in a zoomed-in state. The user interactions of FIGS. 11A-11D illustrate a possible panning algorithm for navigating in the x-y plane of a graphical user interface. For ease of explanation, the initially selected object 210l-1 (object number 2 in all four diagrams) has been zoomed to fill the viewing window 201l vertically with large left and right margins allowing the user to see some non-selected objects (e.g. object numbers 0, 1, 3, 4, 5) to the sides. The center of the viewing window 201l is marked by a crosshairs, where it assumed that the initially selected object 210l-1 is centered at the beginning of each user interaction.

As represented by the closed and open hand icons connected by the arrows in FIG. 11A, the user has begun a click and drag operation (closed hand) using a mouse, for example, at the horizontal center of the viewing window 201 on the selected and zoomed object 210l-1. The user has then dragged to the left a short distance before releasing (open hand). As shown in the right-hand frame of FIG. 11A, the result of this user interaction is that the graphical user interface has sprung back to its initial position, with the object 210l-1 in the center of the viewing window 201l and still selected. In FIG. 11B, the user has similarly dragged the selected object 210l-1 to the left, this time going farther and releasing just as the border of object number 3 reaches the center of the viewing window 201l. Again, as shown in the right-hand frame, the graphical user interface springs back to its initial position and object number 2 is still selected. In FIG. 11C, the user has again dragged the selected object 210l-1 to the left, but this time the user has dragged so far that object number 3 is closer to the center of the viewing window 201l than the selected object 210l-1 (object number 2). Therefore, as shown in the right-hand side of FIG. 11C, object number 3 has snapped to position at the center of the viewing window 201 as the newly selected object 210l-2. In FIG. 11D, the user has dragged the selected object 210l-1 so far to the left that object number 4 is closer to the center of the viewing window 201l than the selected object 210l-1 (object number 2) and closer to the center of the viewing window 201l than object number 3. Therefore, as shown in the right-hand side of FIG. 11D, object number 4 has snapped to position at the center of the viewing window 201 as the newly selected object 210l-2.

In the above examples of FIGS. 11A-11D, object numbers 0, 1, 2, 3, 4, 5 are the same size, so the selection of a new object 210l-2 does not cause the EZUI apparatus 100 to change the spatial dimensions of any objects. However, more generally, once a new object 210l-2 has been selected, in addition to centering the new object 210l-2 as described, the EZUI apparatus 100 may further zoom in on the new object 210l-2 (or zoom out on the new object 210l-2) in accordance with the spatial dimensions of the viewing window 201 and any designated margins 230 and may deform any non-selected objects 220 (including the previously selected object 210l-1) proportionally as described above.

The following is an exemplary EZUI navigation algorithm that may be performed by the EZUI apparatus 100 in accordance with the above when a user pans in the x-y plane of the viewing window 201 (e.g. by a click and drag operation) after the graphical user interface has been zoomed in on an initially selected object. Upon completion of the panning operation toward a new object, the EZUI apparatus 100 may determine whether the center of the new object is aligned with the center of the viewing window 201. If it is, the new object is considered to be selected and no further positioning adjustments may be necessary as the newly selected object is already positioned correctly (but may still be deformed as its spatial dimensions are changed in accordance with the spatial dimensions of the viewing window 201). If the new object is not aligned with the center of the viewing window, the EZUI apparatus 100 may measure the distance between the object's center and the center of the viewing window 201. The EZUI apparatus 100 may determine whether the difference is equal to or less than half the length of the object in the panning direction, in which case the graphical user interface is scrolled in the opposite direction of the panning direction a distance equal to the difference (i.e. back to the initial position) and the new object is not selected. If, on the other hand, the difference is greater than half the length of the object in the panning direction, the graphical user interface is scrolled in the panning direction a distance equal to the object's length in the panning direction minus the difference, placing the center of the new object at the center of viewing window 201. In this case, the new object is selected as the newly selected object and may be deformed as described herein (with the previously selected object and other non-selected objects being deformed accordingly).

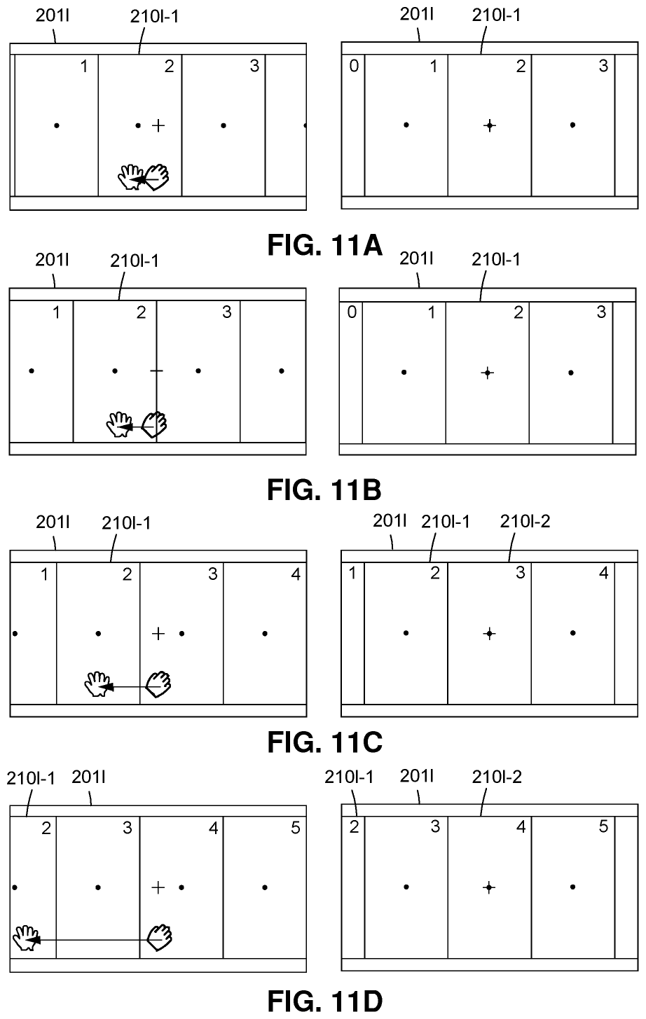

FIG. 12 shows an example operational flow for performing a zoom according to an embodiment of the present disclosure. Referring to the system 10 shown in FIG. 1 by way of example, where a user of an electronic device 200 has interacted with a graphical user interface displayed thereon, the operational flow may begin with receiving a user selection of an object 210 (step 1210) in a viewing window 201 of a graphical user interface, determining an initial set of spatial dimensions of the selected object 210 (step 1220), determining an initial set of spatial dimensions of any non-selected object(s) 220 (step 1230), and determining a set of spatial dimensions of the viewing window 201 (step 1240). For example, the object data input interface 110 of the EZUI apparatus 100 may receive the user's selection of the object 210 and determine the spatial dimensions of the selected object 210 and any non-selected object(s) 220, outputting the results to the zoom engine 130. The spatial dimensions of the objects 210, 220 may be measured at the time of selection or prior to the time of selection or may, in some cases, be known a priori by the EZUI apparatus 100, for example, in the case where the objects 210, 220 initially have predetermined sizes that do not depend on the viewing window 201. The viewing window data input interface 120 may determine the spatial dimensions of the viewing window 201 at the time of selection or at any earlier time (step 1240) and may likewise output the spatial dimensions of the viewing window 201 to the zoom engine 130. Steps 1220, 1230, and 1240 may further include determining initial positions of the objects 210, 220 and viewport (corresponding to viewing window 201) on a canvas as described above.

The operational flow of FIG. 12 may continue with calculating a final set of spatial dimensions of the selected object 210 (step 1250) and a final set of spatial dimensions of each non-selected object 220 (step 1260) and transforming the selected object 210 and any non-selected objects 220 accordingly (step 1270). For example, the selected object scaler 132 of the zoom engine 130 may calculate the final set of spatial dimensions of the selected object 210, and the non-selected object scaler 136 of the zoom engine 130 may then calculate the final set of spatial dimensions of the non-selected object(s) 220 based at least partly on the output of the selected object scaler 132. The selected object transformer 134 and the non-selected object transformer 138 may then transform the objects 210, 220 according to the respective final spatial dimensions. As described above, the transformation of the objects 210, 220 may dramatically change the aspect ratios, sizes, and shapes of the objects (e.g. using dual scale factors) in order to allow the user to focus on the selected object 210 without distraction while transforming the surrounding objects proportionally in an intuitive and natural way that is not disorienting to the user.

The selected object scaler 132 and non-selected object scaler 136 may additionally calculate final positions of the selected and non-selected objects 210, 220 (step 1270) as described above, according to the disclosed algorithm (see Table 6), for example. The objects 210, 220 may be transformed accordingly, including scaling and repositioning (step 1280), by the selected object transformer 134 and non-selected object transformer 136. Lastly, the selected object 210 may also be repositioned at the center of the viewing window 201, with the other objects 220 being repositioned accordingly. This may be done by adjusting a viewport position (step 1290) relative to the canvas according to the above algorithm (see Table 7), for example. The rescaling and/or repositioning, as well as the adjustment of the viewport to center the selected object 210 in the viewing window 201, may be accompanied by a single, smooth animation from the initial spatial dimensions and positions of the objects 210, 220 and viewport to the final spatial dimensions and positions of the objects 210, 220 and view port. In this regard, the order of the steps shown in FIG. 12 is for purposes of explanation only, with many of the steps being combinable or ordered differently depending on preferences and coding considerations when implementing the EZUI magnification operation.

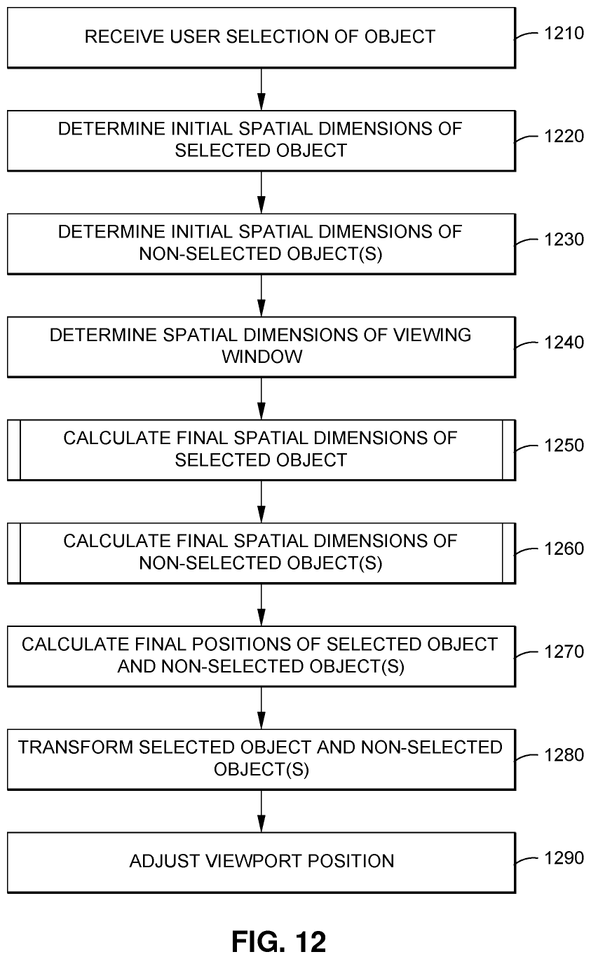

FIG. 13 shows an example subprocess of step 1250 in FIG. 12. The example subprocess provides an operational flow in the specific case where the viewing window 201 is rectangular. In this situation, the set of spatial dimensions of the viewing window 201 may include a first spatial dimension defining a length parallel to a first axis and a second spatial dimension defining a length parallel to a second axis. The first and second axes may be an orthogonal x-axis and y-axis defining an x-y plane, for example. As shown, the calculation of the final spatial dimensions of the selected object 201 (step 1250 in FIG. 12) may include subtracting one or more margins 230 (see FIG. 4) from the viewing window 201. For example, the selected object scaler 132 of the zoom engine 130 may subtract one or more predetermined margins 230 from the first spatial dimension (e.g. width x) of the viewing window 201 (step 1252), such as left and right margins 230 (which may be individually defined). The selected object scaler 132 may further subtract one or more predetermined margins 230 from the second spatial dimension (e.g. height y) of the viewing window 201 (step 1254), such as top and bottom margins 230 (which may be individually defined). The selected object scaler 132 may then scale the initial first and second spatial dimensions of the selected object 210 to match the viewing window 201 (step 1256). As such, the new first spatial dimension of the selected object 210 may match the corresponding first dimension of the viewing window 201 with the left and right margin(s) 230 subtracted therefrom, and the new second spatial dimension of the selected object 210 may match the corresponding second dimension of the viewing window 201 with the top and bottom margin(s) 230 subtracted therefrom. In this way, the selected object 210 may be made to efficiently fit in the viewing window 201 to allow the user to focus on the desired information.

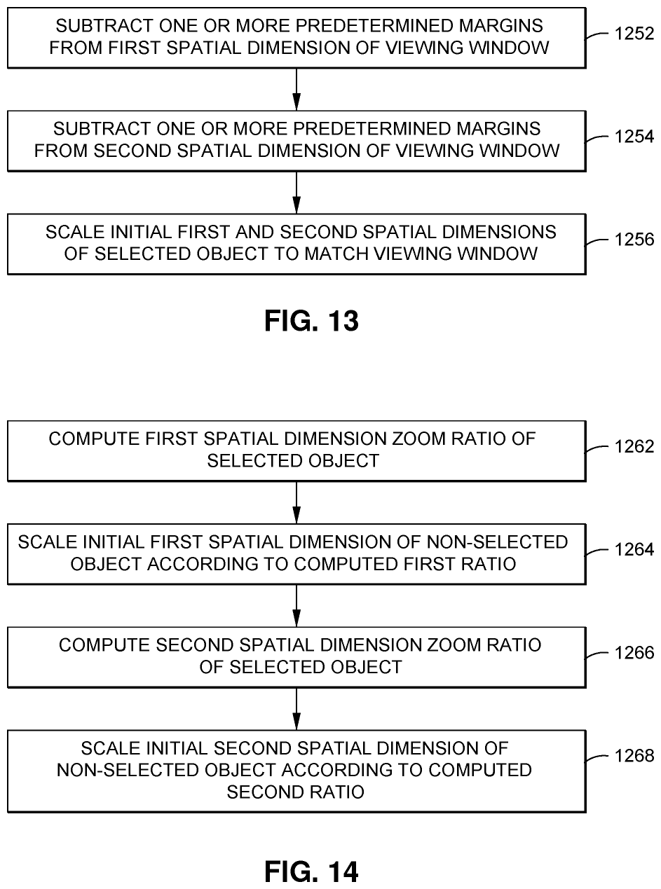

FIG. 14 shows an example subprocess of step 1260 in FIG. 12. The example subprocess continues with the specific case of FIG. 13 where the viewing window 201 is rectangular and additionally assumes that the selected and non-selected objects 210, 220 are rectangular as well. As such, the set of spatial dimensions of each of the objects 210, 220 may likewise include a first spatial dimension (e.g. width x) defining a length parallel to the first axis and a second spatial dimension (e.g. height y) defining a length parallel to the second axis. The operational flow may include computing a first spatial dimension magnification ratio of the selected object 210, e.g. F_S_H, (step 1262) and scaling the initial first spatial dimension of a given non-selected object 220 according to the computed first ratio (step 1264). The operational flow may further include computing a second spatial dimension magnification ratio of the selected object 210, e.g. F_S_V, (step 1266) and scaling the initial second spatial dimension of the non-selected object 220 according to the computed second ratio (step 1268). For example, with the selected object scaler 132 having scaled the first and second spatial dimensions of the selected object 210 to match the viewing window 201 (minus any margins 230) in step 1256 of FIG. 13, the selected object scaler 132 may compute and output the resulting first and second magnification ratios (one for each spatial dimension) representing the ratio of the final to initial width x or height y. The non-selected object scaler 136 may then scale the first and second spatial dimensions of each non-selected object 220 by the same magnification ratios. For example, if the width x of the selected object 210 doubles and the height y of the selected object 210 triples in order to match the viewing window 201 (minus margins 230), the non-selected object scaler 136 may likewise double and triple the respective widths x and heights y of each non-selected object 220. In this way, the non-selected objects 220 may be transformed in proportion to the transformation of the selected object 210 to create an intuitive zoom (and an intuitive accompanying animation).

Throughout the above disclosure, it is assumed for ease of explanation that the EZUI apparatus 100 supports only a fixed zoom interface, i.e. one in which the magnification levels are determined by the system and not freely adjustable by the user as part of the magnification operation. However, the disclosure is not intended to be limited in this respect. For example, it is contemplated that a user may be able to freely zoom in or out, either incrementally or along a sliding scale, between the initial state of the graphical user interface where the objects 210, 220 have their initial spatial dimensions and the final state of the graphical user interface where the objects 210, 220 have their final spatial dimensions. In such a case, it is contemplated that the EZUI apparatus 100 could support more than two data levels that the user can reveal or hide by moving forward and backward along the z-axis.

As noted above, magnifying a selected object 210 as described herein may reveal one or more additional data layers. In this regard, it should be noted that the objects 210, 220 may in general be thought of as containers, with each object containing a visual representation of data in two or more data layers corresponding to magnification states of the container. The EZUI magnification operation described throughout the disclosure may adjust the size and shape (and position) of this container in accordance with the size and shape (and position on a canvas) of the viewing window 201 and/or the magnification ratios of other objects, which may have the effect of revealing a new data layer. In order to efficiently take advantage of the new size and shape of the container after it is adjusted, it is contemplated that the layout of the visual representation of data in the newly revealed data layer may responsively adjust to the transforming of the selected object 210. For example, the size and placement of text, images, and other data may be automatically selected or adjusted to better fit within the new spatial dimensions of the selected object 210, ensure legibility of text, promote easy interaction with buttons, etc.

Throughout the above disclosure, the reference numbers 200, 201, 210, 220, and 230 may refer generically to any of the correspondingly numbered elements of any of the disclosed embodiments, with the appended letter a, b, c, etc. being used to refer to a specific instance of the generic reference number.

As noted above, the EZUI apparatus 100 may be embodied in a computer program product that may reside within or otherwise communicate with an electronic device 200 such as a laptop computer, smartphone, or smartwatch. The computer program product may comprise one or more non-transitory program storage media located in one or more devices such as a plurality of networked devices. For example, a mobile device 200 such as a smartphone may include the computer program product in the form of a memory containing a mobile application installed thereon, and the viewing window 201 may represent at least a portion of a display screen of the mobile device 200. As another example, the computer program product may be included in a server that is remote from but in communication with the electronic device 200 (e.g. over the Internet), and the viewing window may represent at least a portion of a display area of a web browser or other application installed on the remote electronic device 200. By way of example, the EZUI may be accessible through a web browser or ported web application to desktop or a native mobile application, with the browser or the operating system of the mobile device compiling the source code. A web application embodying the EZUI apparatus 100 may run on the Internet or in some cases may be a dedicated web application that is only locally available. For example, in the case of an intranet, the web app may be run on a local server machine, with only those computers that are part of the network able to reach the web application.

In this regard, the functionality described in relation to the components of the EZUI apparatus 100 shown in FIG. 1 and the various operational flows described in relation to FIGS. 12-14 (as well as the various user interfaces described in relation to FIGS. 2-11) may be wholly or partly embodied in a computer including a processor (e.g., a CPU), a system memory (e.g., RAM), and a hard drive or other secondary storage device. The processor may execute one or more computer programs, which may be tangibly embodied along with an operating system in a computer-readable medium, e.g., the secondary storage device. The operating system and computer programs may be loaded from the secondary storage device into the system memory to be executed by the processor. The computer may further include a network interface for network communication between the computer and external devices (e.g., over the Internet), such as the electronic device 200 accessing the various user interfaces described throughout this disclosure via a mobile application or web browser.

The computer programs may comprise program instructions which, when executed by the processor, cause the processor to perform operations in accordance with the various embodiments of the present disclosure. The computer programs may be provided to the secondary storage by or otherwise reside on an external computer-readable medium such as cloud storage in a cloud infrastructure (e.g. Amazon Web Services, Azure by Microsoft, Google Cloud, etc.), a DVD-ROM, an optical recording medium such as a CD or Blu-ray Disk, a magneto-optic recording medium such as an MO, a semiconductor memory such as an IC card, a tape medium, a mechanically encoded medium such as a punch card, etc. Other examples of computer-readable media that may store programs in relation to the disclosed embodiments include a RAM or hard disk in a server system connected to a communication network such as a dedicated network or the Internet, with the program being provided to the computer via the network. Such program storage media may, in some embodiments, be non-transitory, thus excluding transitory signals per se, such as radio waves or other electromagnetic waves. Examples of program instructions stored on a computer-readable medium may include, in addition to code executable by a processor, state information for execution by programmable circuitry such as a field-programmable gate arrays (FPGA) or programmable logic array (PLA).

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A computer program product comprising one or more non-transitory program storage media on which are stored instructions executable by one or more processors or programmable circuits to perform operations for performing a magnification operation in relation to an object displayed on a graphical user interface, the operations comprising:
receiving a user selection of an object displayed on a graphical user interface;
determining an initial set of spatial dimensions of the selected object;
determining an initial set of spatial dimensions of one or more non-selected objects displayed on the graphical user interface;
determining a set of spatial dimensions of a viewing window of the graphical user interface;
in response to the user selection, positioning the selected object in a center of the viewing window, calculating a final set of spatial dimensions of the selected object based on the set of spatial dimensions of the viewing window, and calculating a final set of spatial dimensions of the one or more non-selected objects based on the initial set of spatial dimensions of the selected object, the final set of spatial dimensions of the selected object, and the initial set of spatial dimensions of the one or more non-selected objects;
transforming the selected object according to the calculated final set of spatial dimensions of the selected object; and
transforming the one or more non-selected objects according to the calculated final set of spatial dimensions of the one or more non-selected objects.

2. The computer program product of claim 1, wherein each of the sets of spatial dimensions includes a first spatial dimension defining a length parallel to a first axis and a second spatial dimension defining a length parallel to a second axis.

3. The computer program product of claim 2, wherein said calculating the final set of spatial dimensions of the one or more non-selected objects includes:
calculating a final first spatial dimension of the one or more non-selected objects based on the initial first spatial dimension of the selected object, the final first spatial dimension of the selected object, and the initial first spatial dimension of the one or more non-selected objects, irrespective of the initial second spatial dimension of the selected object, the final second spatial dimension of the selected object, and the initial second spatial dimension of the one or more non-selected objects; and
calculating the final second spatial dimension of the one or more non-selected objects based on the initial second spatial dimension of the selected object, the final second spatial dimension of the selected object, and the initial second spatial dimension of the one or more non-selected objects, irrespective of the initial first spatial dimension of the selected object, the final first spatial dimension of the selected object, and the initial first spatial dimension of the one or more non-selected objects.

4. The computer program product of claim 2, wherein
said calculating the final first spatial dimension of the one or more non-selected objects includes:
computing a first ratio of the final first spatial dimension of the selected object to the initial first spatial dimension of the selected object; and
scaling the initial first spatial dimension of the one or more non-selected objects according to the computed first ratio, and
said calculating the final second spatial dimension of the one or more non-selected objects includes:
computing a second ratio of the final second spatial dimension of the selected object to the initial second spatial dimension of the selected object; and
scaling the initial second spatial dimension of the one or more non-selected objects according to the computed second ratio.

5. The computer program product of claim 2, wherein said calculating the final first and second spatial dimensions of the selected object includes subtracting a predetermined margin from one or both of the first and second spatial dimensions of the viewing window.

6. The computer program product of claim 1, wherein said transforming the selected object includes displaying an animation of the selected object from the initial set of spatial dimensions of the selected object to the final set of spatial dimensions of the selected object.

7. The computer program product of claim 6, wherein said transforming the one or more non-selected objects includes displaying an animation of the one or more non-selected objects from the initial set of spatial dimensions of the one or more non-selected objects to the final set of spatial dimensions of the one or more non-selected objects.

8. The computer program product of claim 1, wherein the initial set of spatial dimensions of the selected object define a rectangle, and the final set of spatial dimensions of the selected object define a non-rectangle.

9. The computer program product of claim 8, wherein said transforming the selected object includes displaying an animation of the selected object deforming from the rectangle to the non-rectangle.

10. The computer program product of claim 1, wherein the final set of spatial dimensions of the selected object define a rectangle, and the initial set of spatial dimensions of the selected object define a non-rectangle.

11. The computer program product of claim 10, wherein said transforming the selected object includes displaying an animation of the selected object deforming from the non-rectangle to the rectangle.

12. The computer program product of claim 1, wherein the operations further comprise:
determining an initial position of each of the one or more non-selected objects;
calculating a final position of each of the one or more non-selected objects based on the initial set of spatial dimensions of the selected object, the final set of spatial dimensions of the selected object, and the initial position of the non-selected object; and
positioning each of the one or more non-selected objects according to the calculated final position of the non-selected object.

13. The computer program product of claim 12, wherein
each of the sets of spatial dimensions includes a first spatial dimension defining a length parallel to a first axis and a second spatial dimension defining a length parallel to a second axis,
the initial positions of each of the one or more non-selected objects includes a first component along the first axis and a second component along the second axis, and
said calculating the final position of each of the one or more non-selected objects includes:
computing a first ratio of the final first spatial dimension of the selected object to the initial first spatial dimension of the selected object;
scaling the first component of the initial position of the non-selected object according to the computed first ratio;
computing a second ratio of the final second spatial dimension of the selected object to the initial second spatial dimension of the selected object; and
scaling the second component of the initial position of the non-selected object according to the computed second ratio.

14. The computer program product of claim 1, wherein the operations further comprise:
after said transforming the selected object and after said transforming the one or more non-selected objects, receiving a navigation command newly selecting an object from among the one or more non-selected objects in place of the previously selected object;
in response to the navigation command, positioning the newly selected object in the center of the viewing window, calculating a new set of spatial dimensions of the newly selected object based on the set of spatial dimensions of the viewing window, and calculating a new set of spatial dimensions of the previously selected object based on the initial set of spatial dimensions of the newly selected object, the new set of spatial dimensions of the newly selected object, and the initial set of spatial dimensions of the previously selected object;
transforming the newly selected object according to the calculated new set of spatial dimensions of the newly selected object; and
transforming the previously selected object according to the calculated new set of spatial dimensions of the previously selected object.

15. The computer program product of claim 14, wherein the navigation command comprises a drag command positioning the newly selected object within a predetermined distance from the center of the viewing window.

16. The computer program product of claim 1, wherein the selected object comprises a container containing a visual representation of data in two or more data layers corresponding to magnification states of the container.

17. The computer program product of claim 16, wherein a layout of the visual representation of data in at least one of the two or more data layers responsively adjusts to said transforming the selected object.

18. A mobile device comprising the computer program product of claim 1, wherein the viewing window is at least a portion of a display screen of the mobile device.

19. A server comprising the computer program product of claim 1, wherein the viewing window is at least a portion of a display area of a web browser or other application installed on a remote device.

20. A method of performing a magnification operation in relation to an object displayed on a graphical user interface, the method comprising:
receiving a user selection of an object displayed on a graphical user interface;
determining an initial set of spatial dimensions of the selected object;
determining an initial set of spatial dimensions of one or more non-selected objects displayed on the graphical user interface;
determining a set of spatial dimensions of a viewing window of the graphical user interface;
in response to the user selection, positioning the selected object in a center of the viewing window, calculating a final set of spatial dimensions of the selected object based on the set of spatial dimensions of the viewing window, and calculating a final set of spatial dimensions of the one or more non-selected objects based on the initial set of spatial dimensions of the selected object, the final set of spatial dimensions of the selected object, and the initial set of spatial dimensions of the one or more non-selected objects;
transforming the selected object according to the calculated final set of spatial dimensions of the selected object; and
transforming the one or more non-selected objects according to the calculated final set of spatial dimensions of the one or more non-selected objects.

21. A system for performing a magnification operation in relation to an object displayed on a graphical user interface, the system comprising:
a first electronic device with a display screen supporting a first viewing window having a set of spatial dimensions;
an object data input interface for receiving a user selection of an object displayed on a graphical user interface, determining an initial set of spatial dimensions of the selected object, and determining an initial set of spatial dimensions of one or more non-selected objects displayed on the graphical user interface;
a viewing window data input interface for determining the set of spatial dimensions of the first viewing window; and
a magnification engine that, in response to receiving the user selection from the first electronic device, positions the selected object in a center of the first viewing window, calculates a final set of spatial dimensions of the selected object based on the set of spatial dimensions of the first viewing window, and calculates a final set of spatial dimensions of the one or more non-selected objects based on the initial set of spatial dimensions of the selected object, the final set of spatial dimensions of the selected object, and the initial set of spatial dimensions of the one or more non-selected objects,
wherein the magnification engine transforms the selected object according to the calculated final set of spatial dimensions of the selected object and transforms the one or more non-selected objects according to the calculated final set of spatial dimensions of the one or more non-selected objects.

22. The system of claim 21, further comprising:
a second electronic device with a display screen supporting a second viewing window having a set of spatial dimensions different from the set of spatial dimensions of the first viewing window,
wherein the viewing window data input interface determines the set of spatial dimensions of the second viewing window, and
wherein the magnification engine, in response to receiving the user selection from the second electronic device, positions the selected object in a center of the second viewing window, calculates a final set of spatial dimensions of the selected object based on the set of spatial dimensions of the second viewing window, and calculates a final set of spatial dimensions of the one or more non-selected objects based on the initial set of spatial dimensions of the selected object, the final set of spatial dimensions of the selected object, and the initial set of spatial dimensions of the one or more non-selected objects.
